(19) United States
(12) Patent Application Publication
(10) Pub. No.: US 2009/0288558 A1
(43) Pub. Date: Nov. 26, 2009

(54) Nonwovens of controlled stiffness and retained foldability

(76) Inventors: Leonard E. Duello, Hewitt, TX (US); Thomas D. Hawkins, Waco, TX (US); Christopher B. Peart, Kingsport, TN (US)

Correspondence Address: ALIX YALE & RISTAS LLP, 750 MAIN STREET, SUITE 1400, HARTFORD, CT, 06103, US

(21) Appl. No.: 12/227,304

(22) PCT Filed: May 16, 2007
(86) PCT No.: PCT/FI2007/050281

§ 371 Date: Apr. 13, 2009

Related U.S. Application Data
(60) Provisional application No. 60/866,820, filed on Nov. 21, 2006.
(60) Provisional application No. 60/800,613, filed on May 16, 2006.

(51) Int. Cl. B01D 39/14; D04H 13/00; B03C 3/38

(52) U.S. Cl. 96/27; 156/148; 55/524

(57) ABSTRACT

The present disclosure relates generally to a nonwoven filtration media comprising a bonded mix of different, discontinuous, thermoplastic resin fibers and optionally discontinuous cellulosic fibers. The nonwoven media has an advantageous combination of stiffness, foldability, efficiency and the ability to retain a fold. The nonwoven media can be thermally bonded during the production process. The advantageous combination of mechanical properties allow the disclosed nonwoven media to accept and retain folds and pleats better than some conventional filtration materials while the mix of different fibers provides desirable filtration properties.

### FIELD

The present disclosure relates generally to a nonwoven web comprising a mix of discontinuous, thermoplastic resin fibers having a combination of high stiffness, foldability and filtration properties. The nonwoven web can advantageously be used as a filtration media. The present disclosure also provides a method of making the nonwoven web.

### BACKGROUND

Some desirable filtration properties of nonwoven fabrics used as filtration media are that they be permeable to the fluid being filtered yet have high filtration efficiency. High permeability to the fluid being filtered is desirable, as less energy is required to move the fluid through the filter media. High filtration efficiency is, of course, desirable as it allows the filtration media to more effectively remove contaminants in the fluid being filtered. Filtration properties can be quantified using tests such as Frazier Permeability, dP, PFE efficiency and Index.

In many applications, filtration media are required which have structural integrity by themselves for conversion into various shapes. For example, the filtration media can be folded into a pleated shape that gives far more surface area than a non-pleated shape in the same space.

Large fibers in a filtration media provide stiffness for pleating but undesirably degrade filtration efficiency. Further, some stiff filtration media are difficult to fold and may not “hold” the pleat, allowing the pleat to close and degrading filtration properties. Small fibers in a filtration media improve efficiency and foldability but reduce stiffness. A filtration media having an advantageous combination of stiffness, foldability, filtration properties and the ability to retain a fold is desirable.

### SUMMARY

The present disclosure relates generally to a nonwoven filtration media comprising a bonded mix of different, discontinuous, thermoplastic resin fibers and optionally discontinuous cellulosic fibers. The nonwoven media has an advantageous combination of Gurley Stiffness, an LED score foldability within a preselected range dependent on the Gurley Stiffness, filtration properties and the ability to retain a fold. The nonwoven filtration media can be thermally bonded during the production process. The advantageous combination of high stiffness and foldability properties allow the disclosed nonwoven media to accept and retain folds and pleats better than some conventional filtration materials while the mix of different fibers provides desirable filtration properties.

One embodiment of a nonwoven filtration media comprises a mix of 0 percent to about 90 percent of staple length fibers having a denier of 10 or greater and about 10 percent to about 100 percent of the fibers having a denier of 4 or less. About 30 percent to about 85 percent of the fibers will be conjugate fibers. Preferably, the nonwoven filtration media will comprise a mixture of 0 percent to about 85 percent conjugate fibers having a denier of 15 or more and 0 percent to about 80 percent of conjugate fibers having a denier of 4 or less. The staple length fibers are carded and cross-lapped to form a single layer with the different fibers homogeneously distributed through the thickness of the layer. The nonwoven filtration media is thermally bonded by contact with heated rollers. This nonwoven filtration media will have a basis weight between about 90 g/m² to about 370 g/m², a Frazier Permeability between about 762 l/m²/s (150 CFM/square foot) and about 4320 l/m²/s (850 CFM/square foot), a PFE greater than or equal to 30 percent, a dP between about 0.76 mm (0.03 inches) water gauge at 0.56 m/s (110 fpm) and about 5.5 mm (0.22 inches) water gauge at 0.56 m/s (110 fpm), an Index between about 300 and about 1600 a MD Gurley stiffness of more than 1400 and an LED score foldability within a preselected range dependent on the Gurley Stiffness

One embodiment of a nonwoven filtration media comprises a mix of staple length fibers all having a denier of 5 or less. Advantageously, about 30 percent to about 85 percent of the fibers in the nonwoven filtration media will be conjugate fibers having a denier of 5 or less. The staple length fibers are carded and cross-lapped to form a single layer with the different fibers homogeneously distributed through the thickness of the layer. The nonwoven filtration media is thermally bonded by contact with heated rollers. This nonwoven filtration media will have a basis weight between about 90 g/m² to about 370 g/m², a Frazier Permeability between about 762 l/m²/s (150 CFM/square foot) and about 4320 l/m²/s (850 CFM/square foot), a PFE greater than or equal to 30 percent, a dP between about 0.76 mm (0.03 inches) water gauge at 0.56 m/s (110 fpm) and about 5.5 mm (0.22 inches) water gauge at 0.56 m/s (110 fpm), an Index between about 300 and about 1600 a MD Gurley stiffness of more than 1400 and an LED score foldability within a preselected range dependent on the Gurley Stiffness

The disclosed nonwoven filtration media may be used in a number of different applications. The media is advantageously used in air filtration for home or commercial heating, ventilating and air conditioning (HVAC) services. It may also be used in filtration of breathing air in transportation applications like automobile cabin air filtration, airplane cabin air filtration, and train and boat air filtration. While the nonwoven filtration media is preferably directed to air filtration, in different embodiments other gasses and other fluids may be filtered as well. Such other gasses may include, for example, nitrogen. Other fluids may include liquids like oil or water.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure and understanding the concept and embodiments disclosed herein, a person of ordinary skill can, without inventive effort, explore beyond the disclosed limits and, when embodiments are found to be without any unexpected characteristics, those embodiments are within the meaning of the term about as used herein.

### DEFINITIONS

Biconstituent fiber—A fiber that has been formed from a mixture of two or more polymers extruded from the same spinneret. Biconstituent fibers do not have the various polymer components arranged in relatively constantly positioned distinct zones across the cross-sectional area of the fiber and the various polymers are usually not continuous along the entire length of the fiber, instead usually forming fibrils which start and end at random. Biconstituent fibers are sometimes also referred to as multiconstituent fibers.

Binder—An adhesive material used to bind a web of fibers together or bond one web to another. The principal properties of a binder are adhesion and cohesion. The binder can be in solid form, for example a powder, film or fiber, in liquid form, for example a solution, dispersion or emulsion or in foam form.

Bonding—The process of securing fibers or filaments to each other in a nonwoven web. The fibers or filaments can be secured by thermally bonding such as in calendering or through air bonding; mechanical means such as in needle punching; or jets of pressurized fluid such as water in hydroentangling.

Calendering—the process of moving a nonwoven material between opposing surfaces. The opposing surfaces include flat platens, rollers, rollers having projections and combinations thereof. Either or both of the opposing surfaces may be heated.

Card—A machine designed to separate fibers from impurities, to align the fibers and deliver the aligned fibers as a batt or web. The fibers in the web can be aligned randomly or parallel with each other predominantly in the machine direction. The card consists of a series of rolls and drums that are covered with a plurality of projecting wires or metal teeth.

Carded web—A nonwoven web of discontinuous fibers produced by carding.

Carding—A process for making nonwoven webs on a card.

Cellulose fiber—A fiber comprised substantially of cellulose. Cellulosic fibers come from manmade sources (for example, regenerated cellulose fibers or lyocel fibers) or natural sources such as cellulose fibers or cellulose pulp from woody and non-woody plants. Woody plants include, for example, deciduous and coniferous trees. Non-woody plants include, for example, cotton, flax, esparto grass, kenaf, sisal, abaca, milkweed, straw, jute, hemp, and bagasse.

Cellulose material—A material comprised substantially of cellulose. The material may be a fiber or a film. Cellulosic materials come from manmade sources (for example, regenerated cellulose films and fibers) or natural sources such as fibers or pulp from woody and non-woody plants.

Conjugate fiber—A fiber comprising a first fiber portion extending substantially continuously along the length of the fiber and comprising a first thermoplastic polymeric material having a first melting point and a second fiber portion extending substantially continuously along the length of the fiber and defining at least a portion of a fiber exterior surface, the second fiber portion comprising a second thermoplastic polymeric material having a second melting point. Typically, the second melting point is lower than the first melting point. The fiber portions are arranged in substantially constantly positioned distinct zones across the cross-section of the fiber. A conjugate fiber includes fibers comprising two or more polymers or fiber portions. Conjugate fibers are formed by extruding polymer sources from separate extruders through a spinneret to form a single fiber. Typically, different polymeric materials are extruded from each extruder, although a conjugate fiber may encompass extrusion of the same polymeric material from separate extruders. The configuration of conjugate fibers can be symmetric (e.g., sheath:core or side:side) or they can be asymmetric (e.g., offset core within sheath; crescent moon configuration within a fiber having an overall round shape). The shape of the conjugate fiber can be any shape that is convenient to the producer for the intended end use, e.g., round, trilobal, triangular, dog-boned, flat or hollow.

Cross machine direction (CD)—The nonwoven web direction perpendicular to the machine direction.

Denier—A unit used to indicate the fineness of a filament given by the weight in grams for 9,000 meters of filament. A filament of 1 denier has a mass of 1 gram for 9,000 meters of length.

Entanglement—A method of bonding a web by interlocking or wrapping fibers in the web about each other. The method may use mechanical means such as in needle punching or jets of pressurized fluid such as water in hydroentangling.

Fiber—A material form characterized by an extremely high ratio of length to diameter. As used herein, the terms fiber and filament are used interchangeably unless otherwise specifically indicated.

Filament—A substantially continuous fiber. As used herein, the terms fiber and filament are used interchangeably unless otherwise specifically indicated.

Foam bonding—A method of applying a binder in a foam form to a fibrous web. The foam form contains less fluid than the same material in a liquid form and thus requires less energy and time to dry the foam and cure the binder.

Lyocel—Manmade cellulose material obtained by the direct dissolution of cellulose in an organic solvent without the formation of an intermediate compound and subsequent extrusion of the solution of cellulose and organic solvent into a coagulating bath.

Machine direction (MD)—The long direction of a nonwoven web material that is parallel to and in the direction in which the nonwoven web material is finally accumulated.

Meltblown fiber—A fiber formed by extruding a molten thermoplastic material as filaments from a plurality of fine, usually circular, die capillaries into a high velocity gas (e.g., air) stream which attenuates the filaments of molten thermoplastic material to reduce their diameter. Thereafter, the meltblown fibers are carried by the high velocity gas stream and are deposited on a collecting surface to form a web of randomly dispersed meltblown fibers. The meltblown process includes the melt spray process.

Monocomponent fiber—A fiber formed from one or more extruders using only one polymer. This is not meant to exclude fibers formed from one polymer to which small amounts of additives have been added for coloration, anti-static properties, lubrication, hydrophilicity, etc. These additives, e.g. titanium dioxide for color, are generally present in low amounts such as less than 5 weight percent.

Needle punching or Needling—A method of bonding a web by interlocking or wrapping fibers in the web about each other. The method uses a plurality of barbed needles to carry fiber portions in a vertical direction through the web.

Non-thermoplastic polymer—Any polymer material that does not fall within the definition of thermoplastic polymer.

Nonwoven fabric, sheet or web—A material having a structure of individual fibers that are interlaid, but not in an identifiable manner as in a woven or knitted fabric. Nonwoven materials have been formed from many processes such as, for example, meltblowing, spin laying, carding, air laying and water laying processes. The basis weight of nonwoven materials is usually expressed in weight per unit area, for example in grams per square meter (g/m²) or ounces per square foot (osf) or ounces per square yard (osy). As used herein a nonwoven sheet includes a wetlaid paper sheet.

Polymer—A long chain of repeating, organic structural units. Generally includes, for example, homopolymers, copolymers, such as for example, block, graft, random and alternating copolymers, terpolymers, etc, and blends and modifications thereof. Furthermore, unless otherwise specifically limited, the term “polymer” includes all possible geometrical configurations. These configurations include, for example, isotactic, syndiotactic and random symmetries.

Regenerated cellulose—Manmade cellulose obtained by chemical treatment of natural cellulose to form a soluble chemical derivative or intermediate compound and subsequent decomposition of the derivative to regenerate the cellulose. Regenerated cellulose includes spun rayon and cellophane film. Regenerated cellulose processes include the viscose process, the cuprammonium process and saponification of cellulose acetate.

Short fiber—A fiber that has been formed at, or cut to, lengths of generally one quarter to one half inch (6 mm to 13 mm).

Spunlaid filament—A filament formed by extruding molten thermoplastic materials from a plurality of fine, usually circular, capillaries of a spinneret. The diameter of the extruded filaments is then rapidly reduced as by, for example, eductive drawing and/or other well-known mechanisms. Spunlaid fibers are generally continuous with deniers within the range of about 0.1 to 5 or more.

Spunbond nonwoven web—Webs formed (usually) in a single process by extruding at least one molten thermoplastic material as filaments from a plurality of fine, usually circular, capillaries of a spinneret. The filaments are partly quenched and then drawn out to reduce fiber denier and increase molecular orientation within the fiber. The filaments are generally continuous and not tacky when they are deposited onto a collecting surface as a fibrous batt. The spunlaid fibrous batt is then bonded by, for example, thermal bonding, calendering, chemical binders, mechanical needling, hydraulic entanglement or combinations thereof, to produce a nonwoven fabric.

Staple fiber—A fiber that has been formed at, or cut to, staple lengths of generally one quarter to eight inches (6 mm to 200 mm).

Synthetic fiber—a fiber comprised of manmade material, for example glass, polymer, combination of polymers, metal, carbon, regenerated cellulose or lyocel.

Substantially continuous—in reference to the polymeric filaments of a nonwoven web, it is meant that a majority of the filaments or fibers formed by extrusion through orifices remain continuous as they are drawn and then impacted on a collection device. Some filaments may be broken during the attenuation or drawing process, with a substantial majority of the filaments remaining continuous.

Tex—A unit used to indicate the fineness of a filament given by the weight in grams for 1,000 meters of filament. A filament of 1 tex has a mass of 1 gram for 1,000 meters of length.

Thermal point bonding—A calender process comprising passing a web of fibers to be bonded between a heated calender roll and an anvil roll. The calender roll is usually, though not always, patterned in some way so that the fabric is not bonded across its entire surface and the anvil is usually flat. Filaments or fibers in the bonding area are joined by heat and pressure imparted by the rolls. Typically, the percent bonding area varies from around 10% to around 30% of the web surface area. Thermal point bonding can also be used to join layers together in a composite material as well as to impart integrity to each individual layer by bonding filaments and/or fibers within each layer.

Thermoplastic polymer—A polymer that softens and is fusible when exposed to heat, returning generally to its unsoftened state when cooled to room temperature. Thermoplastic materials include, for example, polyvinyl chlorides, some polyesters, polyamides, polyfluorocarbons, polyolefins, some polyurethanes, polystyrenes, polyvinyl alcohol, copolymers of ethylene and at least one vinyl monomer (e.g., poly (ethylene vinyl acetates), and acrylic resins.

Triboelectrically charged fibers—Two yarns of dissimilar polymers rubbed together and exchange charges in such a consistent manner that one fiber forms a positive charge and the other a negative charge.

### BRIEF DESCRIPTION OF THE DRAWINGS

Referring now to the drawings wherein like elements are numbered alike in the several Figures:

FIG. 1 is an illustration of preparation of a specimen for the LED score foldability test.

FIG. 2 is an illustration of compression of a specimen for the LED score foldability test.

FIG. 3 is an illustration of measurement of the LED score test angle.

FIG. 4 is an illustration of a Gurley Stiffness specimen showing orientation of the specimen to the nonwoven filtration media.

FIG. 5 is an illustration of a LED Score specimen showing orientation of the specimen to the nonwoven filtration media.

FIG. 6 is a schematic illustration of one embodiment of a thermal bonding system using a single heated roller.

FIG. 7 is a schematic illustration of one embodiment of a thermal bonding system using multiple heated rollers.

FIG. 8 is a graph of MD Gurley Stiffness versus LED foldability for some of the Examples

### DETAILED DESCRIPTION

In one embodiment, a thermally bonded nonwoven filtration media comprising a mixture of discontinuous fibers is disclosed. The different fibers are substantially homogeneously distributed throughout the thickness of the media. The nonwoven filtration media has an advantageous combination of Gurley Stiffness, foldability within a predetermined range dependent on the Gurley Stiffness and filtration efficiency.

The nonwoven filtration media can be comprised of many different staple length fibers, including synthetic fibers and cellulose fibers. Advantageously, the synthetic fibers include thermoplastic polymer fibers such as one or more of polyester, polyolefin and polyamide. Typically, at least some of the polymer fibers will be conjugate fibers. Advantageously, about 30 percent to about 85 percent of the polymer fibers will be conjugate fibers. As used in this disclosure fiber percentages are by weight of total fibers in the final nonwoven filtration media. Some suitable synthetic fibers are listed below.

| Denier | Polymer | Supplier |
|---|---|---|
| 4 denier | conjugate polyester core | Stein of West Point GA |
| | and polyester sheath | |
| 15 denier | Polyester (pe) | Stein |
| 2.25 denier | Polyester | RSM of Charlotte, NC |
| 3 denier | Polyester | Invista of Spartanburg, SC |
| 3 denier | Polypropylene (pp) | American Synthetics of |
| | | Pendergrass, GA |

Triboelectrically charged fibers can comprise a combination of 2 to 4 decitex low finish or scoured polypropylene fibers and 2 to 4 denier scoured modacrylic fibers.

Advantageously the cellulosic fibers include one or more of cotton fibers, rayon fibers, lyocel fibers and kenaf bast fibers. Other cellulosic fibers may be useful in the disclosed nonwoven filtration media. It is believed that the cost of some cellulosic fiber materials, for example lyocel, may limit their use in some applications.

Some suitable cellulosic fibers are listed below.

| Denier | Polymer | Supplier |
|---|---|---|
| Mixed | Polyester/cotton | Leigh Fibers of Charlotte, NC |
| 3.33 denier | Lyocel | Tencel of Axis, AL |
| Mixed | Cotton | Leigh Fibers |

The nonwoven filtration media can also comprise a mixture or blend of recycled, staple length polyester fibers and cotton fibers.

The chosen fiber denier for each fiber type of the nonwoven filtration media will be in the range of about 0.1 to about 45. Presently, nonwoven materials comprising 6 denier fibers, for example 6 denier polyester fibers, are excluded from some disclosed embodiments.

Some exemplary staple fibers for use in the disclosed nonwoven filtration media are 0.9 denier monocomponent polyester fibers; 2.25 denier monocomponent polyester fibers; 3 denier monocomponent polyester fibers; 3 denier monocomponent polypropylene fibers; 4 denier polyester core/polyester sheath conjugate fibers; 10 denier polyester core/polyester sheath conjugate fibers; 15 denier monocomponent polyester fibers; 15 denier polyester core/polyester sheath conjugate fibers; 45 denier monocomponent polyester fibers; 2 to 4 decitex low finish or scoured polypropylene fibers; 2 to 4 denier scoured modacrylic fibers; kenaf fibers; and rayon fibers. Naturally, fibers of other deniers, other polymers and other configurations may prove useful in the disclosed nonwoven filtration media.

The nonwoven filtration media will have a basis weight (weight per unit area) of about 0.3 ounces per square foot (osf) (about 90 g/m²) and up. The high limit for basis weight will depend on the end use application. Advantageously, the nonwoven filtration media will have a basis weight of about 0.3 osf (about 90 g/m²) to about 1.2 osf (about 370 g/m²).

The nonwoven filtration media will have a thickness of about 0.04 inches (about 1 mm) to about 0.25 inches (about 6.4 mm) or more depending on the end use application. Advantageously, the nonwoven filtration media will have a thickness of about 0.08 inches (about 2.0 mm) to about 0.12 inches (about 3 mm).

There are numerous known technologies for forming a nonwoven filtration media from staple length fibers, including air laying, foam laying, wet laying and carding. Presently, carding is considered an advantageous method for making the nonwoven filtration media. Preselected types of staple length fibers are mixed in preselected proportions and the mixture is fed to a card machine. The card machine forms the mixed fibers into a matt. Fibers in the carded matt will be homogeneously distributed, although the majority of fibers will typically be aligned in the machine direction. The matt may optionally be layered using, for example, a cross lapper machine. The cross lapper machine layers the lighter web leaving the card. The carded web enters the cross lapper machine in one direction and the layered matt leaves the cross lapper machine in a direction perpendicular to the entry direction. The layered matt will typically have an increased basis weight as compared to the carded matt. The layered matt may have a cross direction fiber orientation, although fibers in the layered matt are typically more randomly oriented than in the carded matt.

Many technologies can be employed to join or bond the fibers in the matt. Some useful bonding technologies include, for example, one or more of entangling, thermal calendering of the matt to fuse thermoplastic fibers therein, application of ultrasonic energy to the matt and/or application of resin materials to the matt. Presently, mechanical entanglement such as needle punching is considered advantageous for joining fibers of the matt.

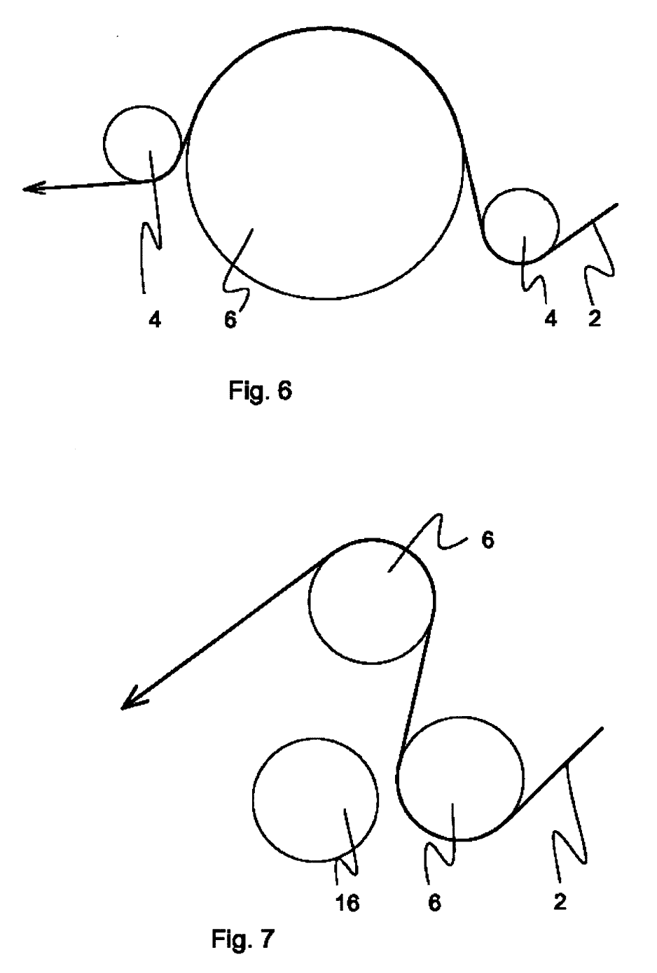

Heat can be applied to the entangled matt 2 to at least partially melt the thermoplastic fibers therein. Upon cooling, the melted thermoplastic fibers harden and fuse the fibers in the entangled matt. One advantageous method of thermal bonding is running the entangled matt over one or more heated rolls 6. The media can be threaded through the system utilizing additional rolls, which may not be shown, to heat one or both sides of the entangled matt. FIG. 6 schematically illustrates one embodiment of a thermal bonding system using a single heated roller 6, and two idlers 4 guiding the travel of the nonwoven filtration media 2. FIG. 7 schematically illustrates one embodiment of a thermal bonding system using multiple heated rollers 6. The third roll 16 in FIG. 7 can optionally be moved into contact with the opposite side of the matt 2 for compression and heating of the matt 2. The rolls 6 and 16 are heated to a temperature sufficient to soften and fuse the thermoplastic fibers in the nonwoven filtration media. Suitable temperatures are generally in the range of about 149° C. (300° F.) to about 215° C. (420° F.), depending on the matt contact time. The thermally bonded matt can optionally be further bonded by passing the matt through ovens after thermal bonding over heated rollers. It may be possible to thermally bond the matt by oven heating alone to form the disclosed nonwoven filtration media. Nonwoven filtration media bonded using both heated rollers and oven are exemplified in examples 166, 180 and 211 (See tables 5 and 6).

Resin binders can be added to the nonwoven filtration media after carding or bonding. Some suitable resin binders are ethylene vinyl chloride, ethylene vinyl acetates, acrylics and acrylates. Resin binders are typically applied as a solution and are dried and/or cured by heating. The resin binder solution can be added using conventional processes, for example, by spraying or dipping the matt.

The nonwoven filtration media can be coupled to a second nonwoven web to form a composite filtration media. The second nonwoven web can be comprised of continuous filaments, for example a spunbonded web, or discontinuous fiber, for example a carded web or a wet laid web. Typically, the coupled media and web will be in continuous face to face contact. The coupled webs can be joined by adhesive bonding; thermal bonding; mechanical entanglement or ultrasonic bonding. Alternately, the nonwoven filtration media can be used as a base over which charged fibers, such as triboelectrically charged fibers, can be laid and mechanically entangled. Additionally, different layers comprising cotton and polyester-cotton mixtures layers can be layered between the nonwoven filtration media and the triboelectrically charged fibers. See Table 6, Examples 208 to 210.

After formation and bonding, the filtration media material may be charged or corona treated. Corona treatment further increases filtration efficiency by drawing particles to be filtered toward the nonwoven filtration media by virtue of its electrical charge. Corona treatment can be carried out by a number of different techniques. One technique is described in U.S. Pat. No. 5,401,446 to Tsai et al. assigned to the University of Tennessee Research Corporation and incorporated herein by reference in its entirety. Other methods of corona treatment are known in the art.

The disclosed nonwoven filtration media may be made into a filter by any suitable means known in the art, for example by rotary pleating. Rotary pleating, while faster than many other pleating methods, is indicated to be quite dependent upon the stiffness of the filter medium. Gurley Stiffness values of at least 600 mg are required to allow pleating on high-speed rotary pleating equipment. Other methods of pleating are not as sensitive to filtration media stiffness but are slower. Rotary pleating is discussed in, for example, U.S. Pat. No. 5,709,735 to Midkiff and Neely.

In one presently preferred method, preselected types of staple length fibers are mixed in preselected proportions. The staple length fiber mixture is fed to a card machine. The card machine forms the mixed, staple length fibers into a matt. The matt is cross-lapped to increase basis weight and rearrange fiber orientation. The carded and lapped matt is needle punched to mechanically entangle the fibers therein. The entangled matt is thermally bonded by running the matt over one or more heated rolls. The matt can also be optionally compressed by rolls during thermal bonding. Liquid resin binders are optionally applied to the thermal bonded matt. The binder comprising matt is heated to dry the matt and/or to cure the binder. A nonwoven web can optionally be superimposed on the carded matt prior to needle punching so that the carded matt and nonwoven web are mechanically entangled into a composite filtration media.

As discussed above the nonwoven filtration media has an advantageous combination of Gurley Stiffness, foldability within a predetermined range dependent on the Gurley Stiffness and filtration properties. Filtration properties can be quantified using tests such as Frazier Permeability, dP, PFE efficiency and Index. Test methods are discussed below.

Frazier Air Permeability

Frazier air permeability test is a measure of the permeability of a filtration media to air. The Frazier test is performed in accordance with ASTM D461-72, D737-75, F778-82, TAPPI T251 and ISO 9237, and is reported as an average of 4 sample readings. The test reports the amount of air that flows in cubic feet per minute per square foot at a resistance of 12.7 mm (0.5″) water gauge. CFM/square foot results can be converted to liters per square meter per second (l/m²/s) by multiplying CFM/square foot by 5.08. It is believed advantageous that the disclosed nonwoven filtration media have a Frazier Permeability in the range of about 762 l/m²/s (150 CFM/square foot) to about 4320 l/m²/s (850 CFM/square foot).

dP and PFE Efficiency

dP and PFE are test results from ASHRAE standard ASHRAE 52.2-1999. dP is pressure drop or resistance as measured in inches of water gauge at 0.56 m/s (110 feet per minute) air velocity. PFE is the particle fraction/filtering efficiency i.e. particle removal efficiency percentage at 0.56 m/s (110 feet per minute) air velocity. One reportable PFE range averages the efficiency between 3 to 10 micron particle sizes and another reportable range averages the efficiency between the 1 to 3 micron particle sizes. It is believed advantageous that the disclosed nonwoven filtration media have a dP in the range of about 0.76 to about 5.6 mm (0.03 to about 0.22 inches) water gauge and a 3 to 10 micron range particle fraction efficiency of between 17.8% and 93.3% and/or a 1 to 3 micron range particle fraction efficiency of between 1.5% and 71.4%.

Index

Index is calculated using the PFE result for 3 to 10 micron efficiency divided by dP. Index is unitless. It is believed advantageous that the disclosed nonwoven filtration media have an Index in the range of about 300 to about 1600.

Gurley Stiffness

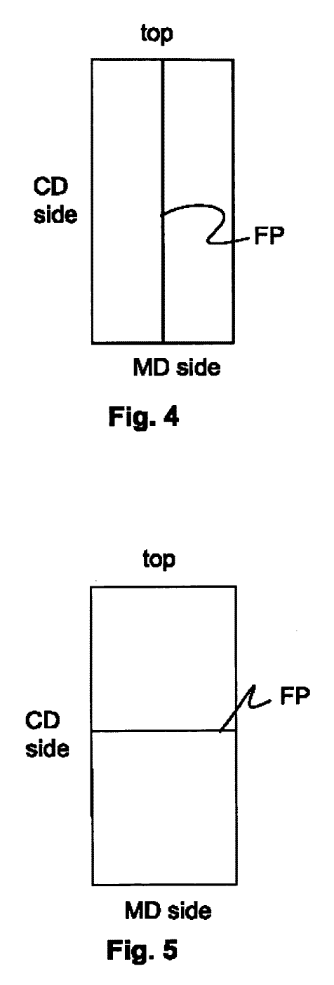

Gurley Stiffness measures nonwoven filtration media stiffness. The Gurley Stiffness test method, discussed in more detail below, generally follows TAPPI Method T 543 om-94. Gurley stiffness is measured in the machine direction (MD) and results are reported in milligrams.
1) Level the tester using the bubble level on front/top.
2) Obtain a square foot sample of media with the MD marked on it, ensuring the product has not been excessively handled or bent.
3) With reference to FIG. 4, cut three specimens across the width that are 25.4 mm×50.8 mm (1″×2″) with 50.8 mm (2″) side being parallel to the CD. Mark samples “CD”. These samples reflect flexure in the MD plane and are used to obtain MD Gurley stiffness values.
4) Cut three specimens across the width that are 50.8 mm×25.4 mm (2″×1″) with 50.8 mm (2″) side being parallel to the MD. Mark samples “CD”. These samples reflect flexure in the CD plane and are used to obtain CD Gurley stiffness values.
5) Set up tester as in table below.
6) Orient the specimen in Gurley holder with 50.8 mm (2″) side in jaws and fuzzy (AIR ENTERING) side facing right, position sample to the right.
7) Always start first arm movement from right to left.
8) Once media releases from vane stop are movement. Wait one minute to allow arm movement to slow and stop it (+/−6.4 mm (+/−¼″)) gently.
9) Start arm movement to left until media releases from vane.
10) Push the converter button and record the record values.
11) Average the three tests for both MD and CD separately and report average of three for each.

| Parameter | Setting |
|---|---|
| Length (inches) | 1.5 (38.1 mm) |
| Width (inches) | 2.0 (50.8 mm) |
| Weight position (inches) | 2.0 (50.8 mm) |
| Weight (grams) | 200 |

The stiffer the nonwoven, the higher the Gurley stiffness reading. A Gurley Bending Resistance Tester model 4171D available from Gurley Precision Instruments of Troy, N.Y. has been found suitable for the above testing.

LED foldability score

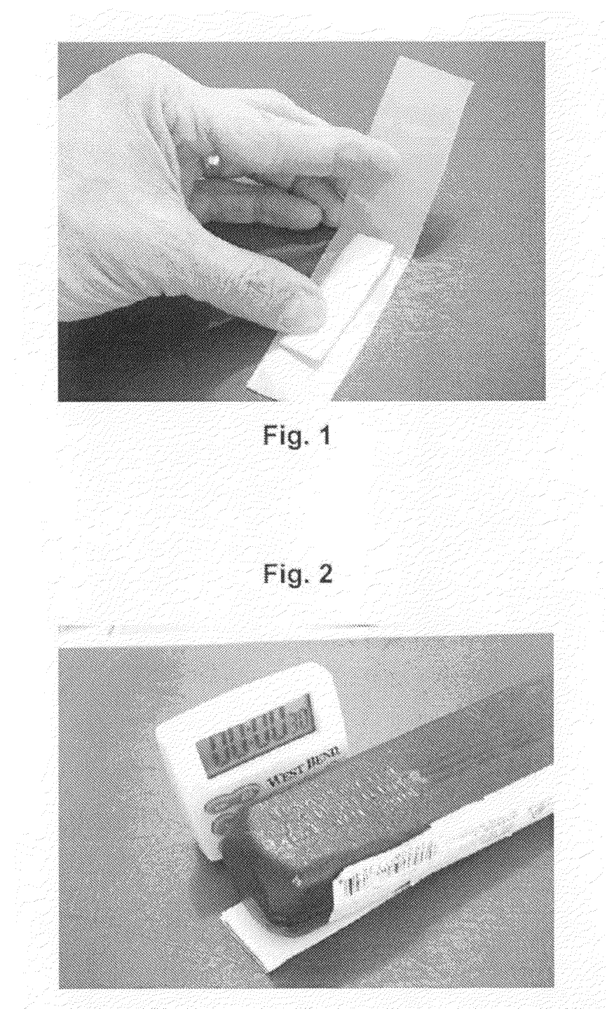

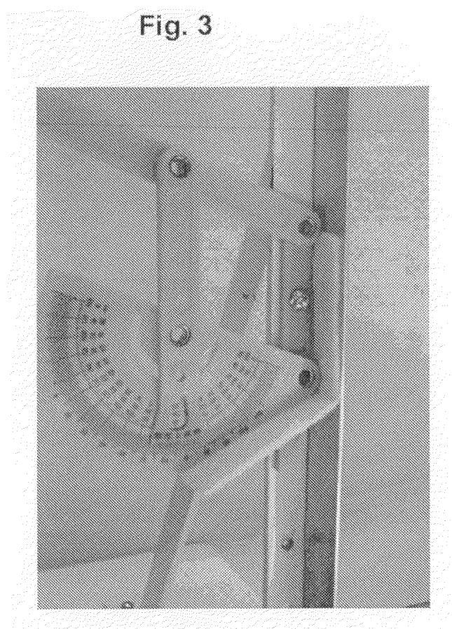

The “LED score” test measures the ability of a nonwoven media to accept and retain a fold. The “LED score” test is similar to a Shirley Crease Retention Test, (American Association of Textile and Color Chemists (AATCC)-66-2003 et al). Briefly, the “LED score” test is performed using the following procedure:
1) Obtain specimen.
2) With reference to FIG. 5, cut specimen into a 12.7 mm (½″) wide x 101.6 mm (4″) long test sample with long direction parallel to CD.
3) Place test sample on flat metal surface.
4) Place angle iron in contact with test sample with apex against sample.
5) Strike angle iron once with 1170 gram hammer.
6) Fold test sample at score (FP) and place in file folder type cardboard sleeve. See FIG. 1.
7) Place folded test sample and sleeve under 1800 gram weight for 30 seconds. See FIG. 2.
8) Remove weight from folded test sample and sleeve and remove test sample from sleeve keeping it closed.
9) Position test sample vertically immediately in front of measuring apparatus.
10) Release and slip vertical leg of test sample into measuring apparatus.
11) Within 3 to 5 seconds align bottom of protractor portion with free leg of test sample.
12) Read “LED Score” test result. See FIG. 3.
13) Repeat three times for each specimen.
14) Average results.
   The measured angle is related to the nonwoven filtration media's resistance to opening, e.g. the ability to retain a fold or pleat. The more foldable a nonwoven, the higher the LED score angle.

The right combination or range of Gurley stiffness and retained foldability properties allows a nonwoven filtration media material to accept and hold a better fold or pleat with a straighter line between the fold peak and valley than other nonwoven filtration medias having properties outside of this range. Such combinations of Gurley stiffness and retained foldability properties are desirable in the manufacture of filter products. Naturally, not every nonwoven will have the advantageous combinations of Gurley stiffness and retained foldability properties disclosed herein. Further, even nonwoven media having similar combinations of Gurley stiffness and retained foldability properties to those disclosed herein will not have the presently disclosed filtration properties.

In some advantageous embodiments of the disclosed nonwoven filtration media the MD Gurley stiffness is above about 2400 milligrams and the retained (LED) foldability is maintained between about 54 degrees and about 101 degrees and preferably between about 61 degrees and about 79 degrees. In some other advantageous embodiments of the disclosed nonwoven filtration media the MD Gurley stiffness is below 2400 milligrams and retained (LED) foldability is maintained between about 40 degrees and about 104 degrees and preferably between about 44 degrees and about 67 degrees.

Especially advantageous combinations of Gurley stiffness and retained (LED) foldability (wherein ranges are indicated by letters A to H) are shown in Table 1.

TABLE 1

| Range | Gurley Stiffness - MD (mg) | Foldability (degrees) |
|---|---|---|
| A | Over 3000 | 60.2 to 101.7 |
| B | 2800 to 3000 | 60.2 to 104.2 |
| C | 2400 to 2800 | 53.3 to 101.5 |
| D | 1800 to 2400 | 39.7 to 105.3 |
| E | 1400 to 1800 | 41.2 to 94.5 |
| F | 1200 to 1400 | 42.0 to 86.0 |
| G | 800 to 1200 | 39.3 to 68.2 |
| H | Under 800 | 42.7 to 68.8 |

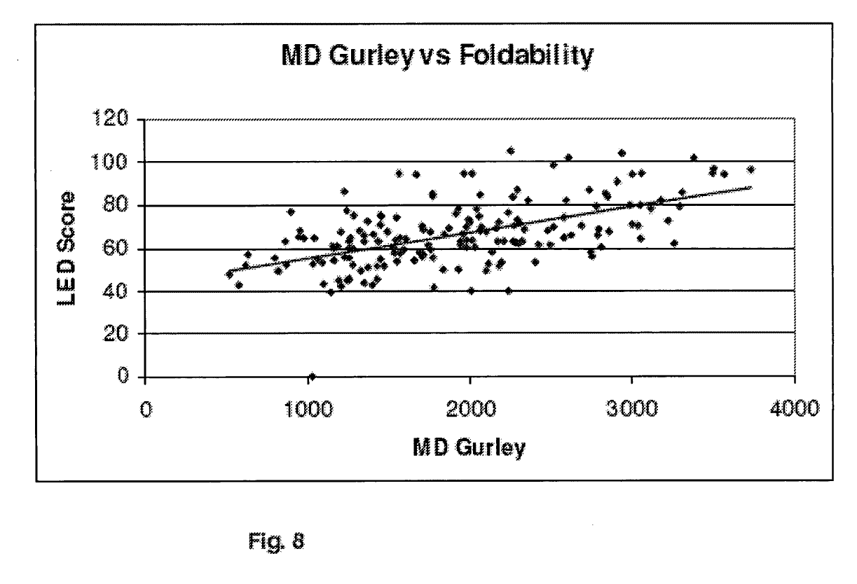

As illustrated in Table 1 and FIG. 8, foldability is seen to increase with MD Gurley stiffness.

Having generally described the invention, the following examples and those on the attached Tables 3 to 5 are included for purposes of illustration so that the invention may be more readily understood and are in no way intended to limit the scope of the invention unless otherwise specifically indicated. Tables 3-5 have been divided on several pages such that each line (except the notes pages) of the table, due to the high number of columns, has been divided on two pages (for example pages 1.1 and 1.2) such that the leftmost column on each page shows the example in question, whereby the lines belonging to the same example may be traced). The Examples were comprised of staple fibers in the combinations shown on the Tables and were prepared using conventional carding and cross-lapping equipment and conditions. Unless otherwise noted the examples were bonded using heated rollers, sometimes in combination with oven heating unless otherwise indicated. Some examples were bonded using ultrasonic energy. Table 6 lists bonding conditions for some examples.
Nonwoven filtration media comprising a mix of staple length fibers having a denier of 4 or less and 10 or more.

Example 2 in range A was prepared by carding fibers to form a nonwoven matt. The matt was thermally bonded over heated rollers. This filtration media comprises 85% staple length fibers having a denier of 4 or less and 15% staple length fibers having a denier of 10 or more. 70% of the fibers of Example 2 are staple length conjugate fibers having a denier less than 4 and a lower melting point polyester sheath, higher melting point polyester core. The fibers are homogeneously distributed throughout the single layer media. This nonwoven filtration media has a basis weight of about 177 g/m², a Frazier permeability of about 1630 m³/s/m² (321 CFM/square foot), a dP of about 0.18, a PFE efficiency of about 58, a MD Gurley stiffness of about 3266 milligrams and a LED score test result of about 62 degrees.

Example 17 in range C was prepared by carding fibers to form a nonwoven matt. The matt was thermally bonded over heated rollers. This filtration media comprises 75% staple length fibers having a denier of 4 or less and 25% staple length fibers having a denier of 10 or more. 50% of the fibers of Example 17 are staple length conjugate fibers having a denier less than 4 and a lower melting point polyester sheath, higher melting point polyester core. The fibers are homogeneously distributed throughout the single layer media. This nonwoven filtration media has a basis weight of about 180 g/m², a Frazier permeability of about 3120 l/m²/s (615 CFM/square foot), a MD Gurley stiffness of about 2630 milligrams and a LED score test result of about 66 degrees.

Example 50 in range E was prepared by carding fibers to form a nonwoven matt. The matt was thermally bonded over heated rollers. This filtration media comprises 75% staple length fibers having a denier of 4 or less and 25% staple length fibers having a denier of 10 or more. 75% of the fibers of Example 50 are staple length conjugate fibers having a denier less than 4 and a lower melting point polyester sheath, higher melting point polyester core. The fibers are homogeneously distributed throughout the single layer media. This nonwoven filtration media has a basis weight of about 131 g/m², a Frazier permeability of about 2950 l/m²/s (580 CFM/square foot), a dP of about 0.076, a PFE efficiency of about 44, a MD Gurley stiffness of about 1770 milligrams and a LED score test result of about 85 degrees.
Nonwoven filtration media comprising staple length fibers all having a denier of 5 or less.

Example 8 in range B was prepared by carding fibers to form a nonwoven matt. The matt was thermally bonded over heated rollers. This filtration media comprises 80% 4 denier, staple length, lower melting point polyester sheath, higher melting point polyester core conjugate fibers; 10% 0.9 denier staple length polyester fibers; and 10% 2.25 denier staple length polyester fibers. The fibers are homogeneously distributed throughout the single layer media. This nonwoven filtration media has a basis weight of about 150 g/m², a Frazier permeability of about 2080 l/m²/s (409 CFM/square foot), a dP of about 0.12, a PFE efficiency of about 50, a MD Gurley stiffness of about 2900 milligrams and a LED score test result of about 91 degrees.

Example 38 in range D was prepared by carding fibers to form a nonwoven matt. The matt was thermally bonded over heated rollers. This filtration media comprises 52% 4 denier, staple length, lower melting point polyester sheath, higher melting point polyester core conjugate fibers; 5% 0.9 denier staple length polyester fibers; and 43% 2.25 denier staple length polyester fibers. The fibers are homogeneously distributed throughout the single layer media. This nonwoven filtration media has a basis weight of about 180 g/m², a Frazier permeability of about 1730 l/m²/s (340 CFM/square foot), a dP of about 0.16, a PFE efficiency of about 62, a MD Gurley stiffness of about 2000 milligrams and a LED score test result of about 40 degrees.
nonwoven filtration media comprising staple length Kenaf fibers.

Example 18 in range C was prepared by carding and heat bonding fibers to form a nonwoven filtration media. This filtration media comprises 50% 4 denier, staple length, lower melting point polyester sheath, higher melting point polyester core conjugate fibers; 25% 4 denier staple length polyester fibers; and 25% staple length kenaf fibers. The fibers are homogeneously distributed throughout the single layer media. This nonwoven filtration media has a basis weight of about 165 g/m², a Frazier permeability of about 2340 l/m²/s (460 CFM/square foot), a dP of about 0.1, a PFE efficiency of about 52, a MD Gurley stiffness of about 2585 milligrams and a LED score test result of about 64.5 degrees.

Example 21 in range C was prepared by carding and heat bonding fibers to form a nonwoven filtration media. This filtration media comprises 70% 4 denier, staple length, lower melting point polyester sheath, higher melting point polyester core conjugate fibers; 15% 4 denier staple length polyester fibers; and 15% staple length kenaf fibers. The fibers are homogeneously distributed throughout the single layer media. This filtration media has a basis weight of about 168 g/m², a Frazier permeability of about 2180 l/m²/s (430 CFM/square foot), a dP of about 0.1, a PFE efficiency of about 48, a MD Gurley stiffness of about 2515 and a LED score test result of about 69.7 degrees.

Example 61 in range E was prepared by carding and heat bonding fibers to form a nonwoven filtration media. This filtration media comprises 40% 4 denier, staple length, lower melting point polyester sheath, higher melting point polyester core conjugate fibers; 35% 4 denier staple length polyester fibers; and 25% staple length kenaf fibers. The fibers are homogeneously distributed throughout the single layer media. This filtration media has a basis weight of about 160 g/m², a Frazier permeability of about 2670 l/m²/s (525 CFM/square foot), a dP of about 0.08, a PFE efficiency of about 54, a MD Gurley stiffness of about 1650 milligrams and an LED score test result of about 64.5 degrees.

Example 82 in range F was prepared by carding and heat bonding fibers to form a nonwoven filtration media. This filtration media comprises 30% 4 denier, staple length, lower melting point polyester sheath, higher melting point polyester core conjugate fibers; 35% 4 denier staple length polyester fibers; and 35% staple length kenaf fibers. The fibers are homogeneously distributed throughout the single layer media. This filtration media has a basis weight of about 160 g/m², a Frazier permeability of about 2690 l/m²/s (530 CFM/square foot), a dP of about 0.08, a PFE efficiency of about 48, a MD Gurley stiffness of about 1297 milligrams and an LED score test result of about 63.5 degrees.
nonwoven filtration media comprising a blend of recycled, staple length, polyester fibers and cotton fibers.

Example 29 in range D was prepared by carding and heat bonding fibers to form a nonwoven filtration media. This filtration media comprises 70% 4 denier, staple length, lower melting point polyester sheath, higher melting point polyester core conjugate fibers; 15% 0.9 denier staple length polyester fibers; and 15% of a blend of recycled, staple length, polyester fibers and cotton fibers. The fibers are homogeneously distributed throughout the single layer media. One side of the media was run over a roller heated to 193° C. (380° F.) to partially melt and fuse the fibers. This filtration media has a basis weight of about 190 g/m², a Frazier permeability of about 1470 l/m²/s (290 CFM/square foot), a dP of about 0.2, a PFE efficiency of about 66, a MD Gurley stiffness of about 2209 milligrams and a LED score test result of about 63.3 degrees.

Example 30 in range D was prepared by carding and heat bonding fibers to form a nonwoven filtration media. This filtration media comprises 70% 4 denier, staple length, lower melting point polyester sheath, higher melting point polyester core conjugate fibers; and 30% of a blend of recycled, staple length, polyester fibers and cotton fibers. The fibers are homogeneously distributed throughout the single layer media. One side of the media was run over a roller heated to 204° C. (400° F.) to partially melt and fuse the fibers. This filtration media has a basis weight of about 200 g/m², a Frazier permeability of about 1680 l/m²/s (330 CFM/square foot), a dP of about 0.16, a PFE efficiency of about 73, a MD Gurley stiffness of about 2195 milligrams and a LED score test result in the range of about 53.0 degrees.
nonwoven filtration media comprising staple length polypropylene fibers.

Example 75 in range E was prepared by carding and heat bonding fibers to form a nonwoven filtration media. This filtration media comprises about 65% 4 denier, staple length, lower melting point polyester sheath, higher melting point polyester core conjugate fibers; 15% 3 denier staple length uncharged polypropylene fibers; and 20% 0.9 denier staple length polyester fibers. The fibers are homogeneously distributed throughout the single layer media. This filtration media has a basis weight of about 116 g/m², a Frazier permeability of about 2120 l/m²/s (418 CFM/square foot), a MD Gurley stiffness of between about 1411 milligrams and a LED score test result in the range of about 66.5 degrees.

Example 77 in range F was prepared by carding and heat bonding fibers to form a nonwoven filtration media. This filtration media comprises about 40% 4 denier, staple length, lower melting point polyester sheath, higher melting point polyester core conjugate fibers; about 30% 3 denier staple length uncharged polypropylene fibers; and about 30% 15 denier staple length polyester fibers. The fibers are homogeneously distributed throughout the single layer media. One side of the media was run over a roller heated to about 178° C. (352° F.) to partially melt and fuse the fibers. This filtration media has a basis weight of about 160 g/m², a Frazier permeability of about 2610 l/m²/s (514 CFM/square foot), a dP of about 0.08, a PFE efficiency of about 41, a MD Gurley stiffness of about 1371 milligrams and a LED score test result of about 50.8 degrees.

Example 105 in range G was prepared by carding and heat bonding fibers to form a nonwoven filtration media. This filtration media comprises about 60% 4 denier, staple length, lower melting point polyester sheath, higher melting point polyester core conjugate fibers; 25% 3 denier staple length uncharged polypropylene fibers; and about 15% 15 denier staple length polyester fibers. The fibers are homogeneously distributed throughout the single layer media. One side of the media was run over a roller heated to about 178° C. (352° F.) to partially melt and fuse the fibers. This filtration media has a basis weight of about 113 g/m², a Frazier permeability of about 3110 l/m²/s (613 CFM/square foot), a MD Gurley stiffness of about 955 milligrams and a LED score test result in the range of about 65.0 degrees.

Example 111 in range H was prepared by carding and heat bonding fibers to form a nonwoven filtration media. This filtration media comprises 40% 4 denier, staple length, lower melting point polyester sheath, higher melting point polyester core conjugate fibers; 30% 3 denier staple length uncharged polypropylene fibers; and about 30% 15 denier staple length polyester fibers. The fibers are homogeneously distributed throughout the single layer media. One side of the media was run over a roller heated to about 178° C. (352° F.) to partially melt and fuse the fibers. This filtration media has a basis weight of about 120 g/m², a Frazier permeability of about 3200 i/m²/s (630 CFM/square foot), a MD Gurley stiffness of about 637 milligrams and a LED score test result of about 56.7 degrees.
nonwoven filtration media comprising 10 denier, staple length, conjugate polyester fibers.

Example 85 in range F was prepared by carding and heat bonding fibers to form a nonwoven filtration media. This filtration media comprises about 35% 4 denier, staple length, lower melting point polyester sheath, higher melting point polyester core conjugate fibers; about 35% 10 denier, staple length conjugate polyester fibers; and about 30% 0.9 denier staple length polyester fibers. The fibers are homogeneously distributed throughout the single layer media. This filtration media has a basis weight of about 116 g/m², a Frazier permeability of about 2540 l/m²/s (500 CFM/square foot), a dP of about 0.1, a PFE efficiency of about 48, a MD Gurley stiffness of about 1258 milligrams and a LED score test result in the range of about 59.5 degrees.

Example 104 in range G was prepared by carding and heat bonding fibers to form a nonwoven filtration media. This filtration media comprises 55% 4 denier, staple length, lower melting point polyester sheath, higher melting point polyester core conjugate fibers; 10% 10 denier, staple length conjugate polyester fibers; and 35% 3 denier staple length polyester fibers. The fibers are homogeneously distributed throughout the single layer media. This filtration media has a basis weight of about 120 g/m², a Frazier permeability of about 2840 l/m²/s (560 CFM/square foot), a dP of about 0.08, a PFE efficiency of about 38, a MD Gurley stiffness of about 960 milligrams and a LED score test result of about 68.2 degrees.
nonwoven filtration media comprising more than one layer.

Example 19 in range C was prepared by carding and heat bonding fibers to form a first nonwoven filtration media. This first nonwoven media includes about 70% 4 denier, staple length, lower melting point polyester sheath, higher melting point polyester core conjugate fibers and about 30% 15 denier polyester fibers. The first filtration media was needled onto a second spunbond nonwoven filtration media comprising 0.5 osy polypropylene filaments to form the nonwoven composite material. One side of the composite material was run over a roller heated to about 160° C. (320° F.) to partially melt and fuse the fibers. This nonwoven composite material has a basis weight of about 168 g/m², a Frazier permeability of about 2690 l/m²/s (530 CFM/square foot), a MD Gurley stiffness of about 2583 milligrams and a LED score test result of about 74.0 degrees.

Example 26 in range D was prepared by carding and heat bonding fibers to form a first nonwoven filtration media. This first nonwoven media includes about 70% 4 denier, staple length, lower melting point polyester sheath, higher melting point polyester core conjugate fibers and about 30% 15 denier staple length polyester fibers. The first filtration media was needled onto a second spunbond nonwoven filtration media comprising 0.5 osy polypropylene filaments to form the nonwoven composite material. One side of the material was run over a roller heated to about 168° C. (335° F.) to partially melt and fuse the fibers. This nonwoven composite material has a basis weight of about 153 g/m², a Frazier permeability of about 2740 l/m²/s (540 CFM/square foot), a dP of about 0.07, a PFE efficiency of about 44, a MD Gurley stiffness of about 2298 milligrams and a LED score test result of about 86.7 degrees.

Example 169 in range D is a 2 layer nonwoven filtration media. Each layer was an independently carded matt formed using a different card machine. One carded matt comprised 50% 4 denier, staple length, lower melting point polyester sheath, higher melting point polyester core conjugate fibers and 50% 3 denier, staple length polyester fibers. The other carded matt comprised 50% 4 denier, staple length, lower melting point polyester sheath, higher melting point polyester core conjugate fibers and 50% 45 denier, staple length polyester fibers. Each carded matt was cross-lapped using a separate cross lapper. The cross-lapped matts were overlaid, mechanically entangled by needling and thermally bonded using a heated roller. Each carded matt contributed one half to the weight of this 2 layer nonwoven filtration media. This nonwoven composite material has a basis weight of about 150 g/m², a Frazier permeability of about 2540 l/m²/s (500 CFM/square foot), a dP of about 0.075, a PFE efficiency of about 45, a MD Gurley stiffness of about 2300 milligrams and a LED score test result of about 73 degrees.
Resin and thermal bonded nonwoven filtration media.

Nonwoven filtration medias can be bonded using liquid resins.

Example 180 in range D was prepared by carding fibers to form a matt. This matt comprises about 15% 2.25 denier staple length, monocomponent polyester fibers; about 50% 15 denier staple length, lower melting point polyester sheath, higher melting point polyester core conjugate fibers and about 35% 45 denier staple length, monocomponent polyester fibers. The fibers are homogeneously distributed throughout the single layer media. One side of the matt was heated over a heated roller to partially melt and fuse the fibers. A solution of resin binder was applied to the heat bonded matt. The impregnated matt was run through an oven having multiple heating zones with each zone heated to between 116° C. (241) and 148° C. (298° F.). This filtration media has a resin content of about 15 percent by weight of the media, a basis weight of about 140 g/m², a Frazier permeability of about 2950 l/m²/s (580 CFM/square foot), a dP of about 0.04, a PFE efficiency of about 30, a and a MD Gurley stiffness of about 1965 milligrams and a LED score test result of about 94 degrees.

Example 194 in range F was prepared by carding fibers to form a matt. This matt comprises about 35% 3 denier staple length, monocomponent polyester fibers; about 50% 15 denier staple length, lower melting point polyester sheath, higher melting point polyester core conjugate fibers and about 15% 45 denier staple length, monocomponent polyester fibers. The fibers are homogeneously distributed throughout the single layer media. A solution of resin binder was applied to the heat bonded matt. One side of the matt was heated over a heated roller to partially melt and fuse the fibers and dry the resin binder. This filtration media has a resin content of about 15 percent by weight of the media, a basis weight of about 150 g/m², a Frazier permeability of about 3120 l/m²/s (614 CFM/square foot), a MD Gurley stiffness of about 1371 milligrams and a LED score test result of about 72 degrees.

Example 211 in range C was prepared by carding fibers to form a matt. This matt comprises about 10% 4 denier staple length, lower melting point polyester sheath, higher melting point polyester core conjugate fibers; about 65% 15 denier staple length, lower melting point polyester sheath, higher melting point polyester core conjugate fibers and about 25% 45 denier staple length, monocomponent polyester fibers. The fibers are homogeneously distributed throughout the single layer media. One side of the matt was heated over a heated roller to partially melt and fuse the fibers. A solution of resin binder was applied to the heat bonded matt. The impregnated matt was run through an oven having multiple heating zones with each zone heated to between 85 and 104° C. (186 and 220° F.). This filtration media has a resin content of about 15 percent by weight of the media, a basis weight of about 165 g/m², a Frazier permeability of about 3410 l/m²/s (671 CFM/square foot), a dP of about 0.033, a PFE efficiency of about 18, a MD Gurley stiffness of about 2615 milligrams and a LED score test result of about 101.5 degrees.
ultrasonic bonded nonwoven filtration media.

Nonwoven filtration medias can be bonded using ultrasonic energy. Ultrasonic bonding is generally performed using a specifically tuned horn vibrating at a high frequency in close proximity to an anvil roll. The anvil roll can either be flat or have a pattern engraved into the roll.

Example 116 in range H was prepared by carding and ultrasonic bonding fibers to form a nonwoven filtration media. This filtration media comprises about 25% 15 denier polyester fibers; about 25% 45 denier polyester fibers and about 50% 3 denier polypropylene fibers. The fibers are homogeneously distributed throughout the single layer media. This nonwoven filtration media was ultrasonically bonded using a flat anvil roll, a horn and a frequency of 20 kHz, a step position of 7378 with a target force of 800 Newtons on a Hermann Ultrasonics laboratory scale unit (Schaumberg, Ill.). This filtration media has a basis weight of about 170 g/m², a Frazier permeability of about 2100 l/m²/s (413 CFM/square foot), a MD Gurley stiffness of about 140 milligrams and a LED score test result of about 73.3 degrees.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

TABLE 3

| | staple fibers | | | | | | | | | | | | | |
|---|---|---|---|---|---|---|---|---|---|---|---|---|---|---|
| | 4 den. | 15 | 0.9 | 2.25 | | 10 den. | 1599 | 45 | 3 den. | | | | | Thickness |
| | bico fiber | den. | den. | den. | 3 den. | bico fiber | fibers | den. | Charg. | 4 den. | | Weight | Weight | (inches) |
| Ex. | note 1 | pe | pe | pe | pe | note 2 | note 3 | pe | pp | pe | kenaf | (OSF) | (gsm) | note 4 |
| 1 | 50% | | | 25% | | | | 25% | | | | 0.56 | 171 | 0.07 |
| 2 | 70% | | | 15% | | | | 15% | | | | 0.58 | 177 | 0.07 |
| 3 | 70% | | | 15% | | | | 15% | | | | 0.55 | 168 | 0.06 |
| 4 | 60% | 20% | | | | | | 20% | | | | 0.54 | 165 | 0.08 |
| 5 | 60% | 25% | | 15% | | | | | | | | 0.59 | 180 | 0.09 |
| 6 | 80% | | | | 20% | | | | | | | 0.57 | 174 | 0.07 |
| 7 | 50% | | | 25% | | | | 25% | | | | 0.51 | 156 | 0.07 |
| 8 | 80% | | 10% | 10% | | | | | | | | 0.49 | 149 | 0.05 |
| 9 | 80% | 20% | | | | | | | | | | 0.54 | 165 | 0.09 |
| 10 | 80% | | | | 20% | | | | | | | 0.57 | 174 | 0.07 |
| 11 | 60% | 20% | 20% | | | | | | | | | 0.57 | 174 | 0.09 |
| 12 | 70% | 15% | 15% | | | | | | | | | 0.57 | 174 | 0.11 |
| 13 | 70% | 15% | 15% | | | | | | | | | 0.57 | 174 | 0.11 |
| 14 | 50% | | | | 25% | | | 25% | | | | 0.61 | 186 | 0.09 |
| 15 | 50% | | | 25% | | | | 25% | | | | 0.54 | 165 | 0.08 |
| 16 | 50% | 25% | | | | | | 25% | | | | 0.58 | 177 | 0.09 |
| 17 | 50% | 25% | | | | | | 25% | | | | 0.59 | 180 | 0.11 |
| 18 | 50% | | | | | | | | | 25% | 25% | 0.54 | 165 | 0.09 |
| 19 | 70% | 15% | | | | | | | | | | 0.55 | 168 | 0.09 |
| 20 | 50% | 25% | 25% | | | | | | | | | 0.56 | 171 | 0.07 |
| 21 | 70% | | | | | | | | | 15% | 15% | 0.55 | 168 | 0.07 |
| 22 | 50% | 25% | | | | | | 25% | | | | 0.66 | 201 | 0.11 |
| 23 | 70% | | | 15% | | | | 15% | | | | 0.51 | 156 | 0.07 |
| 24 | 40% | | 20% | | | | | 40% | | | | 0.52 | 159 | 0.1 |
| 25 | 60% | 25% | | 15% | | | | | | | | 0.53 | 162 | 0.06 |
| 26 | 70% | 30% | | | | | | | | | | 0.50 | 153 | 0.09 |
| 27 | 50% | 35% | 15% | | | | | | | | | 0.48 | 146 | 0.08 |
| 28 | 60% | 20% | | | 20% | | | | | | | 0.57 | 174 | 0.08 |
| 29 | 70% | | 15% | | | | 15% | | | | | 0.62 | 189 | 0.08 |
| 30 | 70% | | | | | | 30% | | | | | 0.66 | 201 | 0.1 |
| 31 | 50% | 25% | | 25% | | | | | | | | 0.57 | 174 | 0.1 |
| 32 | 60% | 15% | | 25% | | | | | | | | 0.50 | 153 | 0.09 |
| 33 | 50% | 25% | | 25% | | | | | | | | 0.48 | 146 | 0.1 |
| 34 | 70% | | | | | | | 30% | | | | 0.76 | 232 | 0.11 |
| 35 | 30% | | | 35% | | | | 35% | | | | 0.55 | 168 | 0.09 |
| 36 | 60% | 20% | | | | | | 20% | | | | 0.40 | 122 | 0.07 |
| 37 | 50% | | | | 25% | | | 25% | | | | 0.51 | 156 | 0.1 |
| 38 | 52% | | 5% | 43% | | | | | | | | 0.59 | 180 | 0.08 |
| 39 | 50% | 25% | | | | | | 25% | | | | 0.38 | 116 | 0.09 |
| 40 | 50% | 25% | | | | | | 25% | | | | 0.74 | 226 | 0.12 |
| 41 | 60% | 15% | | 25% | | | | | | | | 0.53 | 162 | 0.07 |
| 42 | 50% | | | | 25% | | | 25% | | | | 0.42 | 128 | 0.07 |
| 43 | 60% | 25% | | 15% | | | | | | | | 0.52 | 159 | 0.08 |
| 44 | 70% | 30% | | | | | | | | | | 0.56 | 171 | 0.1 |
| 45 | 70% | 15% | 15% | | | | | | | | | 0.53 | 162 | 0.09 |
| 46 | 40% | 20% | | 40% | | | | | | | | 0.56 | 171 | 0.09 |
| 47 | 60% | 25% | | 15% | | | | | | | | 0.56 | 171 | 0.1 |
| 48 | 60% | 15% | | 25% | | | | | | | | 0.44 | 134 | 0.06 |
| 49 | 40% | | 20% | | | | | 40% | | | | 0.46 | 140 | 0.09 |
| 50 | 50% | | | 25% | | | | 25% | | | | 0.43 | 131 | 0.07 |
| 51 | 60% | | 10% | | 30% | | | | | | | 0.60 | 183 | 0.09 |
| 52 | 60% | 15% | | 25% | | | | | | | | 0.51 | 156 | 0.09 |
| 53 | 50% | | 20% | 30% | | | | | | | | 0.54 | 165 | 0.07 |
| 54 | 50% | 25% | | | 25% | | | | | | | 0.59 | 180 | 0.1 |
| 55 | 50% | 25% | | | | | | 25% | | | | 0.67 | 204 | 0.14 |
| 56 | 50% | | 20% | 30% | | | | | | | | 0.53 | 162 | 0.08 |
| 57 | 70% | 15% | 15% | | | | | | | | | 0.48 | 146 | 0.09 |
| 58 | 50% | 25% | 25% | | | | | | | | | 0.49 | 149 | 0.08 |
| 59 | 70% | | | | | | | 30% | | | | 0.44 | 134 | 0.09 |
| 60 | 60% | 15% | | 25% | | | | | | | | 0.52 | 159 | 0.09 |
| 61 | 40% | | | | | | | | | 35% | 25% | 0.53 | 162 | 0.09 |
| 62 | 50% | 25% | | | | | | 25% | | | | 0.62 | 189 | 0.11 |
| 63 | 60% | 15% | | | | | | | 25% | | | 0.47 | 143 | 0.07 |
| 64 | 52% | | 5% | 43% | | | | | | | | 0.48 | 146 | 0.11 |
| 65 | 60% | 15% | | 25% | | | | | | | | 0.50 | 153 | 0.08 |
| 66 | 80% | 10% | | 10% | | | | | | | | 0.46 | 140 | 0.07 |
| 67 | 50% | 25% | | | 25% | | | | | | | 0.53 | 162 | 0.09 |
| 68 | 60% | 20% | | | 20% | | | | | | | 0.52 | 159 | 0.1 |
| 69 | 30% | | | 35% | | | | 35% | | | | 0.46 | 140 | 0.08 |
| 70 | 60% | 15% | | 25% | | | | | | | | 0.48 | 146 | 0.08 |
| 71 | 50% | 25% | 25% | | | | | | | | | 0.53 | 162 | 0.1 |
| 72 | 50% | | | | | | | | 50% | | | 0.50 | 153 | 0.07 |
| 73 | 60% | 20% | | | 20% | | | | | | | 0.49 | 149 | 0.08 |
| 74 | 70% | | | | 30% | | | | | | | 0.48 | 146 | 0.1 |
| 75 | 65% | | 20% | | | | | | 15% | | | 0.38 | 116 | 0.05 |
| 76 | 50% | | 15% | 35% | | | | | | | | 0.71 | 217 | 0.1 |
| 77 | 40% | 30% | | | | | | | 30% | | | 0.52 | 159 | 0.09 |
| 78 | 50% | 25% | 25% | | | | | | | | | 0.51 | 156 | 0.09 |
| 79 | 50% | | 15% | 35% | | | | | | | | 0.53 | 162 | 0.07 |
| 80 | 40% | 20% | | 40% | | | | | | | | 0.56 | 171 | 0.1 |
| 81 | 55% | | | | 50% | 10% | | | | | | 0.45 | 137 | 0.09 |
| 82 | 30% | | | | | | | | | 35% | 35% | 0.51 | 156 | 0.09 |
| 83 | 60% | 20% | | | 20% | | | | | | | 0.51 | 156 | 0.11 |
| 84 | 40% | 20% | | 40% | | | | | | | | 0.65 | 198 | 0.12 |
| 85 | 35% | | 30% | | | 35% | | | | | | 0.38 | 116 | 0.06 |
| 87 | 40% | 30% | | 30% | | | | | | | | 0.50 | 153 | 0.09 |
| 88 | 52% | | 5% | 43% | | | | | | | | 0.52 | 159 | 0.08 |
| 89 | 60% | 15% | | 25% | | | | | | | | 0.39 | 119 | 0.08 |
| 90 | 80% | 10% | | 10% | | | | | | | | 0.42 | 128 | 0.07 |
| 91 | 50% | 35% | 15% | | | | | | | | | 0.37 | 113 | 0.08 |
| 92 | 52% | | 5% | 43% | | | | | | | | 0.67 | 204 | 0.09 |
| 93 | 70% | 15% | 15% | | | | | | | | | 0.35 | 107 | 0.06 |
| 94 | 60% | 25% | | 15% | | | | | | | | 0.47 | 143 | 0.1 |
| 95 | 50% | 15% | 35% | | | | | | | | | 0.47 | 143 | 0.08 |
| 96 | 70% | | | | | | | 30% | | | | 0.86 | 262 | 0.12 |
| 97 | 50% | 25% | 25% | | | | | | | | | 0.47 | 143 | 0.1 |
| 98 | 40% | 20% | | 40% | | | | | | | | 0.58 | 177 | 0.11 |
| 99 | 50% | | 20% | 30% | | | | | | | | 0.40 | 122 | 0.06 |
| 100 | 50% | 15% | 35% | | | | | | | | | 0.39 | 119 | 0.06 |
| 101 | 70% | | | | 30% | | | | | | | 0.42 | 128 | 0.09 |
| 102 | 70% | 30% | | | | | | | | | | 0.41 | 125 | 0.08 |
| 103 | 60% | | 10% | | 30% | | | | | | | 0.38 | 116 | 0.06 |
| 104 | 55% | | | | 50% | 10% | | | | | | 0.40 | 122 | 0.08 |
| 105 | 60% | 15% | | | | | | | 25% | | | 0.37 | 113 | 0.07 |
| 106 | 50% | 25% | 25% | | | | | | | | | 0.39 | 119 | 0.09 |
| 107 | 50% | 25% | | | 25% | | | | | | | 0.40 | 122 | 0.08 |
| 108 | 50% | | | | | | | | 50% | | | 0.40 | 122 | 0.06 |
| 109 | 50% | | 35% | 15% | | | | | | | | 0.52 | 159 | 0.07 |
| 110 | 50% | | 15% | 35% | | | | | | | | 0.40 | 122 | 0.06 |
| 111 | 40% | 30% | | | | | | | 30% | | | 0.40 | 122 | 0.09 |
| 112 | 50% | 15% | 35% | | | | | | | | | 0.39 | 119 | 0.08 |
| 113 | 40% | 20% | | 40% | | | | | | | | 0.36 | 110 | 0.07 |
| 114 | 52% | | 5% | 43% | | | | | | | | 0.41 | 125 | 0.07 |
| 115 | | 25% | | | | | | 25% | 50% | | | 0.61 | 186 | 0.12 |
| 116 | | 25% | | | | | | 25% | 50% | | | 0.56 | 171 | 0.1 |
| 117 | 50% | | | | | | | | 50% | | | | 0 | |
| 118 | 60% | 15% | | | | | | | 25% | | | | 0 | |
| 119 | 60% | 15% | | | | | | | 25% | | | | 0 | |
| 120 | 40% | 30% | | | | | | | 30% | | | | 0 | |
| 121 | 40% | 30% | | | | | | | 30% | | | | 0 | |
| 122 | 65% | | 20% | | | | | | 15% | | | | 0 | |

| | Frazier | Gurley - MD | Gurley - CD | LED Score | | dP | PFE | |
|---|---|---|---|---|---|---|---|---|
| Ex. | perm. | (mg) | (mg) | test | range | note 5 | note 6 | comments |
| 1 | 499 | 3316 | 3153 | 85.8 | A | 0.106 | 50.3 | |
| 2 | 321 | 3266 | 3155 | 62.2 | A | 0.184 | 57.5 | |
| 3 | 334 | 3225 | 2991 | 72.5 | A | 0.162 | 61.5 | |
| 4 | 377 | 3187 | 2624 | 81.7 | A | 0.141 | 61.6 | |
| 5 | 353 | 3056 | 3064 | 64 | A | 0.129 | 46.7 | |
| 6 | 339 | 3054 | 3044 | 79.7 | A | 0.168 | 66.1 | |
| 7 | 432 | 3038 | 2495 | 70.0 | A | 0.098 | 46.9 | |
| 8 | 409 | 2912 | 2975 | 90.8 | B | 0.117 | 50.2 | |
| 9 | 361 | 2864 | 2099 | 67.3 | B | 0.133 | 49.8 | |
| 10 | 331 | 2855 | 2943 | 83.7 | B | 0.067 | 30.9 | |
| 11 | 411 | 2810 | 2333 | 60.2 | B | 0.107 | 45.5 | |
| 12 | 420 | 2797 | 3301 | 68.7 | B | 0.134 | 55.5 | |
| 13 | 420 | 2797 | 3301 | 68.7 | B | 0.117 | 54.1 | |
| 14 | 511 | 2789 | 1991 | 66 | C | 0.089 | 44.2 | |
| 15 | 491 | 2786 | 2339 | 79.0 | C | 0.095 | 48.1 | |
| 16 | 594 | 2749 | 2764 | 58.2 | C | 0.063 | 20.9 | |
| 17 | 615 | 2629 | 2461 | 66 | C | | | |
| 18 | 457 | 2585 | 2916 | 64.5 | C | 0.099 | 52.2 | |
| 19 | 532 | 2583 | 2634 | 74 | C | | | note 12 |
| 20 | 340 | 2520 | 2949 | 69.5 | C | 0.165 | 61.5 | |
| 21 | 433 | 2516 | 2879 | 69.7 | C | 0.08 | 47.8 | |
| 22 | 559 | 2494 | 2483 | 61.3 | C | 0.07 | 36.5 | |
| 23 | 349 | 2485 | 2694 | 67.8 | C | 0.135 | 60.8 | |
| 24 | 456 | 2423 | 1682 | 61.3 | C | 0.094 | 51.9 | |
| 25 | 398 | 2314 | 2181 | 71.5 | D | 0.13 | 47.1 | |
| 26 | 539 | 2298 | 2113 | 86.7 | D | 0.07 | 44.4 | note 12 |
| 27 | 541 | 2283 | 2601 | 62.6 | D | 0.077 | 44.8 | |
| 28 | 456 | 2283 | 2057 | 62.3 | D | 0.103 | 42.2 | |
| 29 | 288 | 2209 | 2054 | 63.3 | D | 0.211 | 66.3 | |
| 30 | 330 | 2195 | 1755 | 53 | D | 0.161 | 72.9 | |
| 31 | 379 | 2183 | 2259 | 51.3 | D | | | |
| 32 | 465 | 2136 | 1800 | 58 | D | 0.119 | 52.7 | |
| 33 | 477 | 2117 | 1697 | 52.3 | D | 0.106 | 59.4 | |
| 34 | 279 | 2102 | 1477 | 67.3 | D | | | note 7 |
| 35 | 365 | 2035 | 1640 | 60.3 | D | 0.142 | 67.5 | |
| 36 | 474 | 2021 | 2013 | 94.7 | D | 0.094 | 52.8 | |
| 37 | 595 | 2020 | 2098 | 63.7 | D | 0.067 | 39.3 | |
| 38 | 340 | 2013 | 1806 | 40 | D | 0.165 | 62.2 | |
| 39 | 778 | 1998 | 1695 | 73.2 | D | | | |
| 40 | 348 | 1983 | 1365 | 60.3 | D | | | note 8 |
| 41 | 427 | 1981 | 1935 | 63.8 | D | 0.11 | 46.1 | |
| 42 | 656 | 1958 | 1517 | 66.3 | D | 0.056 | 30.6 | |
| 43 | 447 | 1946 | 1926 | 63 | D | 0.107 | 47.4 | |
| 44 | 409 | 1935 | 2139 | 78 | D | 0.122 | 53 | |
| 45 | 414 | 1935 | 1904 | 49.5 | D | 0.139 | 56.2 | |
| 46 | 309 | 1839 | 1394 | 49.5 | D | 0.205 | 60.8 | |
| 47 | 442 | 1780 | 1795 | 41.2 | | 0.099 | 49.3 | |
| 48 | 490 | 1776 | 1734 | 55.5 | E | | | |
| 49 | 538 | 1776 | 1753 | 84.3 | E | | | |
| 50 | 579 | 1772 | 1909 | 85.2 | E | 0.076 | 44.1 | |
| 51 | 348 | 1761 | 1611 | 67.2 | E | 0.216 | 64.6 | |
| 52 | 462 | 1757 | 1736 | 59 | E | 0.108 | 50 | |
| 53 | 316 | 1747 | 1628 | 61.3 | E | 0.179 | 66.9 | |
| 54 | 466 | 1718 | 1689 | 57.2 | E | 0.114 | 49.7 | |
| 55 | 571 | 1715 | 1783 | 68.3 | E | | | |
| 56 | 287 | 1710 | 2213 | 70.3 | E | 0.194 | 71.5 | |
| 57 | 429 | 1710 | 1602 | 55.8 | E | 0.105 | 58.4 | |
| 58 | 379 | 1695 | 1614 | 57.5 | E | 0.15 | 53.6 | |
| 59 | 512 | 1671 | 1537 | 94 | E | | | note 12 |
| 60 | 456 | 1660 | 1653 | 54.2 | E | 0.102 | 46.1 | |
| 61 | 525 | 1650 | 2129 | 64.5 | E | 0.084 | 53.8 | |
| 62 | 412 | 1577 | 1170 | 57.7 | E | | | note 9 |
| 63 | 492 | 1572 | 1313 | 64.5 | E | 0.095 | 42.6 | note 11 |
| 64 | 406 | 1558 | 1451 | | | | | |
| 65 | 478 | 1554 | 1443 | 53.5 | E | 0.096 | 47.4 | |
| 66 | 514 | 1550 | 1844 | 74.3 | E | 0.083 | 49.1 | |
| 67 | 442 | 1543 | 1650 | 63.7 | E | 0.106 | 47.8 | |
| 68 | 504 | 1539 | 1576 | 57.7 | E | 0.08 | 41.6 | |
| 69 | 418 | 1532 | 1517 | 60.2 | E | 0.121 | 63.5 | |
| 70 | 472 | 1495 | 1371 | 67.3 | E | 0.098 | 44 | |
| 71 | 360 | 1477 | 1410 | 51.5 | E | 0.14 | 50.2 | |
| 72 | 405 | 1453 | 1298 | 54.7 | E | 0.12 | 61 | note 11 |
| 73 | 521 | 1441 | 1424 | 62.8 | E | 0.088 | 48.9 | |
| 74 | 490 | 1430 | 1415 | 45.2 | E | 0.087 | 45.4 | |
| 75 | 418 | 1411 | 1581 | 66.5 | E | | | note 11 |
| 76 | 263 | 1403 | 1347 | 42.5 | E | 0.241 | 84.3 | |
| 77 | 514 | 1371 | 1531 | 50.8 | F | 0.079 | 40.7 | note 11 |
| 78 | 387 | 1354 | 1252 | 63.2 | F | 0.14 | 50.7 | |
| 79 | 312 | 1351 | 1275 | 43.5 | F | 0.173 | 65.2 | |
| 80 | 325 | 1328 | 1188 | 49.2 | F | 0.152 | 60.2 | |
| 81 | 488 | 1322 | 1299 | 68 | N | 0.08 | 47.4 | |
| 82 | 533 | 1297 | 1561 | 63.5 | F | 0.078 | 48.2 | |
| 83 | 519 | 1266 | 1140 | 64.7 | F | 0.087 | 52.5 | |
| 84 | 321 | 1261 | 1241 | 45.5 | F | 0.089 | 66.3 | |
| 85 | 502 | 1258 | 1173 | 59.5 | N | 0.1 | 47.8 | |
| 87 | 464 | 1258 | 1270 | 55.3 | F | 0.097 | 48.9 | |
| 88 | 356 | 1243 | 1386 | 45 | F | 0.156 | 67.8 | |
| 89 | 569 | 1228 | 1314 | 55.7 | F | 0.071 | 39.5 | |
| 90 | 548 | 1212 | 1384 | 67.3 | | 0.068 | 40.9 | |
| 91 | 649 | 1206 | 1421 | 42 | | 0.06 | 31.3 | |
| 92 | 258 | 1193 | 1280 | 44.8 | G | 0.23 | 72.7 | |
| 93 | | 1188 | 1232 | 60.7 | G | | | |
| 94 | 538 | 1167 | 1409 | 54 | G | 0.078 | 40.8 | |
| 95 | 432 | 1164 | 1414 | 60 | G | 0.106 | 52.2 | |
| 96 | 246 | 1159 | 1521 | 60.7 | G | | | note 10 |
| 97 | 475 | 1147 | 1105 | 39.3 | G | 0.101 | 50.4 | |
| 98 | 310 | 1099 | 995 | 43.3 | G | | | |
| 99 | 394 | 1095 | 1225 | 53.3 | G | 0.137 | 56.5 | |
| 100 | 394 | 1069 | 1007 | 55 | G | 0.119 | 57.1 | |
| 101 | 530 | 1040 | 1051 | 52.5 | G | 0.079 | 43.6 | |
| 102 | 527 | 1032 | 1173 | too curled | | 0.077 | 43.8 | note 12 |
| 103 | 405 | 977 | 944 | 64.8 | | 0.135 | 49.9 | |
| 104 | 563 | 960 | 1041 | 68.2 | O | 0.078 | 38.1 | |
| 105 | 613 | 955 | 1063 | 65 | | | | note 11 |
| 106 | 543 | 874 | 829 | 52 | G | 0.077 | 49.3 | |
| 107 | 608 | 866 | 810 | 63.2 | G | | | |
| 108 | 483 | 821 | 722 | 49 | G | | | note 11 |
| 109 | 229 | 820 | 912 | 49 | G | 0.246 | 72 | |
| 110 | 388 | 803 | 864 | 55.3 | G | 0.139 | 62.2 | |
| 111 | 632 | 637 | 710 | 56.7 | | | | note 11 |
| 112 | 421 | 622 | 710 | 52 | | 0.116 | 60.8 | |
| 113 | 448 | 577 | 548 | 42.7 | | 0.114 | 50 | |
| 114 | 464 | 522 | 458 | 47.8 | | | | |
| 115 | 232 | 328 | 2422 | 68.8 | | | | |
| 116 | 413 | 140 | 798 | 73.3 | | | | |
| 117 | | | | | | 0.119 | 56.6 | note 11 |
| 118 | | | | | | 0.083 | 34.2 | note 11 |
| 119 | | | | | | 0.057 | 38.7 | note 11 |
| 120 | | | | | | 0.089 | 39.8 | note 11 |
| 121 | | | | | | 0.056 | 25.7 | note 11 |
| 122 | | | | | | 0.136 | 47.3 | note 11 |

Notes for table 3
note 1 - this fiber is a 4 denier, high melting point PET core, low melting point PET sheath bicomponent fiber
note 2 - this fiber is a 10 denier, high melting point PET core, low melting point PET sheath bicomponent fiber
note 3 - this fiber is a polycotton thread shodde or a blend of staple length, recycled polyester fibers and cotton fibers
note 4 - thickness is measured on a 12 inch square sample subjected to a compression of 2 grams per square inch.
note 5 - pressure drop
note 6 - particle filter efficiency, ASHRAE 52.2-1999
note 7 - this is a multilayered composite material comprising a 0.5 osy spunbond layer @ 320/a HPR25LB2DPR layer/a polyester bicomponent fiber comprising staple fiber nonwoven layer
note 8 - this is a multilayered composite material comprising a spunbond layer/a HP29LG2DPR layer @ 375/a polyester bicomponent fiber comprising staple fiber nonwoven layer
note 9 - this is a multilayered composite material comprising a spunbond layer/a HP27LB2DPR layer @ 375/a polyester bicomponent fiber comprising staple fiber nonwoven layer
note 10 - this is a multilayered composite material comprising a 0.5 OSY spunbond layer @ 320/a HP29LG2DPR layer/a polyester bicomponent fiber comprising staple fiber nonwoven layer
note 11 - UNC is uncharged, chgd is charged
note 12 - this is a multilayered composite material comprising a a 0.5 osy spunbond layer

TABLE 4

| | 4 den | 10 den | 15 den | | | | | | |
|---|---|---|---|---|---|---|---|---|---|
| | bico | bico | bico | | | | Weight | Weight | Thickness |
| Example | note 1 | note 2 | note 3 | 0.9 den | 3 den | 45 den | (OSF) | (gsm) | (inches) note 5 |
| 123 | 55% | 10% | | | 50% | | 0.4 | 122 | 0.08 |
| 124 | 35% | 35% | | 30% | | | 0.38 | 116 | 0.06 |
| 125 | 55% | 10% | | | 50% | | 0.45 | 137 | 0.09 |
| 126 | 25% | | 50% | | | 25% | 0.49 | 149 | 0.1 |
| 127 | 50% | | 30% | | 20% | | 0.5 | 153 | 0.08 |
| 128 | 10% | | 65% | | | 25% | 0.54 | 165 | 0.1 |
| 129 | 50% | | 30% | | 20% | | 0.49 | 149 | 0.09 |
| 130 | 25% | | 50% | | | 25% | 0.56 | 171 | 0.08 |
| 131 | 25% | | 50% | | | 25% | 0.56 | 171 | 0.08 |
| 132 | 25% | | 50% | | | 25% | 0.57 | 174 | 0.1 |
| 133 | 35% | 35% | | 30% | | | | | |

| | | MD | | LED | | | | | |
|---|---|---|---|---|---|---|---|---|---|
| | Frazier | Gurley - | CD Gurley - | Score | Pleat | dP | PFE | | MERV, |
| Example | perm. | mg | mg | test | Memory | note 6 | note 7 | Index | est. |
| 123 | 563 | 960 | 1041 | 68.2 | | 0.078 | 38.1 | 488 | 6 |
| 124 | 502 | 1258 | 1173 | 59.5 | | 0.1 | 47.8 | 478 | 6 |
| 125 | 488 | 1322 | 1299 | 68 | | 0.08 | 47.4 | 593 | 6 |
| 126 | 569 | 1569 | 2083 | 94.5 | 5.75 | 0.081 | 43.2 | 533 | |
| 127 | 466 | 2598 | 2609 | 82 | 6.25 | 0.094 | 55.7 | 593 | |
| 128 | 671 | 2615 | 2223 | 101.5 | 4 | 0.033 | 17.8 | 539 | |
| 129 | 472 | 3005 | 2809 | 94.2 | 7.38 | 0.089 | 51.8 | 582 | |
| 130 | 590 | 3382 | 3334 | 101.7 | 8.88 | 0.055 | 41.1 | 747 | |
| 131 | 546 | 3498 | 3683 | 94.7 | 6.63 | | | | |
| 132 | 561 | 3574 | 3584 | 94.2 | 9.31 | | | | |
| 133 | | | | | | | | | |

notes
note 1 - this fiber is a 4 denier, high melting point PET core, low melting point PET sheath bicomponent fiber
note 2 - this fiber is a 10 denier, high melting point PET core, low melting point PET sheath bicomponent fiber
note 3 - this fiber is a 15 denier, high melting point PET core, low melting point PET sheath bicomponent fiber
note 4 - 15 percent binder resin
note 5 - thickness is measured on a 12 inch square sample subjected to a compression of 2 grams per square inch.
note 6 - pressure drop
note 7 - particle filter efficiency, ASHRAE 52.2-1999

TABLE 5

| | 4 denier | 15 | 0.9 | 2.25 | | 15 denier | | 45 | 3 denier | | | |
|---|---|---|---|---|---|---|---|---|---|---|---|---|
| | bico | denier | denier | denier | 3 denier | bico fiber | | denier | chargeable | | Weight | Thickness |
| example | note 1 | polyester | polyester | polyester | polyester | note 2 | 1599 | polyester | polypropylene | comments | (OSF) | note 3 |
| 134 | 60% | 20% | | | 20% | | | | | | 0.4 | 0.08 |
| 135 | 80% | | 10% | 10% | | | | | | | 0.37 | 0.05 |
| 136 | 70% | 15% | | | | | | | | note 11 | 0.43 | 0.09 |
| 137 | 50% | 25% | | | | | | 25% | | | | |
| 138 | 50% | 35% | | 15% | | | | | | | 0.49 | 0.09 |
| 139 | 70% | 15% | | | 15% | | | | | | 0.36 | 0.08 |
| 140 | 35% | | | | 30% | 35% | | | | | 0.41 | 0.08 |
| 141 | 60% | 30% | | | 10% | | | | | | 0.53 | 0.1 |
| 142 | 65% | | | | 20% | | | 15% | | | 0.53 | 0.1 |
| 143 | 55% | 25% | | | 20% | | | | | | 0.5 | 0.1 |
| 144 | 55% | 25% | | | 20% | | | | | | 0.51 | 0.1 |
| 145 | 60% | 20% | | | 20% | | | | | | 0.51 | 0.09 |
| 146 | 60% | 30% | | | | | | | | note 13 | 0.49 | 0.08 |
| 147 | 70% | 30% | | | | | | | | | 0.52 | 0.07 |
| 148 | 70% | 20% | 10% | | | | | | | | 0.5 | 0.09 |
| 149 | 50% | 30% | | 20% | | | | | | | 0.48 | 0.08 |
| 150 | 80% | | 5% | 15% | | | | | | | 0.39 | 0.05 |
| 151 | 80% | | 5% | 15% | | | | | | | 0.44 | 0.05 |
| 152 | 80% | | 5% | | 15% | | | | | | 0.38 | 0.06 |
| 153 | 80% | | | | 20% | | | | | | 0.38 | 0.06 |
| 154 | 60% | 30% | | | 10% | | | | | | 0.5 | 0.08 |
| 155 | 70% | | | | | | 30% | | | | 0.47 | 0.09 |
| 156 | 70% | | | | | | 30% | | | | 0.55 | 0.1 |
| 157 | 70% | | | | | | 30% | | | | 0.41 | 0.09 |
| 158 | 65% | | | | 20% | | | 15% | | | 0.53 | 0.08 |
| 159 | 65% | | | | 20% | | | 15% | | | 0.51 | 0.08 |
| 160 | 60% | | | | 15% | | | 25% | | | 0.49 | 0.08 |
| 161 | | | | | 15% | 50% | | 35% | | | 0.51 | 0.11 |
| 162 | | | | | 35% | 50% | | 15% | | | 0.49 | 0.09 |
| 163 | | | | | 35% | 50% | | 15% | | | 0.46 | 0.09 |
| 164 | 50% | | | | 15% | | | 35% | | | 0.52 | 0.07 |
| 165 | 60% | | | | 15% | | | 25% | | | 0.49 | 0.08 |
| 166 | 60% | | | | 15% | | | 25% | | | 0.51 | 0.11 |
| 167 | 60% | | | | 15% | | | 25% | | | 0.52 | 0.15 |
| 168 | 60% | | | | 15% | | | 25% | | | 0.51 | 0.18 |
| 169 | 50% | | | | 25% | | | 25% | | note 12 | 0.49 | 0.13 |
| 170 | | | | | 15% | 50% | | 35% | | | 0.54 | 0.1 |
| 171 | | | | | 15% | 50% | | 35% | | | 0.58 | 0.1 |
| 172 | | | | 15% | | 50% | | 35% | | | 0.56 | 0.08 |
| 173 | | | | 15% | | 50% | | 35% | | | 0.43 | 0.08 |
| 174 | | | | | | 50% | 30% | 20% | | | 0.51 | 0.1 |
| 175 | 80% | | 10% | 10% | | | | | | | 0.9 | 0.06 |
| 176 | 80% | | 10% | 10% | | | | | | | 0.9 | 0.06 |
| 177 | | | | | | | | | | | | |
| 178 | | | | | | | | | | | | |
| 179 | | | | | | | | | | | | |
| 180 | | | | 15% | | 50% | | 35% | | | 0.47 | 0.1 |
| 181 | | | | 15% | | 50% | | 35% | | | 0.54 | 0.08 |
| 182 | | | | 15% | | 50% | | 35% | | | 0.55 | 0.1 |
| 183 | 10% | | | | | 65% | | 25% | | | 0.54 | 0.11 |
| 184 | 50% | | | | 20% | 30% | | | | | 0.48 | 0.1 |
| 185 | 45% | | | | | 40% | | | 15% | | 0.49 | 0.1 |
| 186 | 45% | | | | | 40% | | | 15% | | 0.48 | 0.1 |
| 187 | 45% | | | | | 40% | | | 15% | | 0.48 | 0.1 |
| 188 | 65% | 15% | | | | | | | 15% | | 0.47 | 0.09 |
| 189 | 70% | 15% | | 15% | | | | | | | 0.52 | 0.07 |
| 190 | | | | | 15% | 50% | | 35% | | | 0.52 | 0.11 |
| 191 | | | | | 20% | 50% | | 30% | | | 0.5 | 0.11 |
| 192 | | | | 20% | | 50% | | 30% | | | 0.5 | 0.1 |
| 193 | | | | 15% | | 50% | | 30% | | | 0.51 | 0.1 |
| 194 | | | | | 35% | 50% | | 15% | | | 0.49 | 0.12 |
| 195 | 35% | | | | | 50% | | 15% | | | 0.43 | 0.08 |
| 196 | | | | 25% | | 60% | | 15% | | | 0.52 | 0.08 |
| 197 | | | | | | 70% | | 10% | | | 0.47 | 0.08 |
| 198 | | | | 15% | | 85% | | | | | 0.43 | 0.06 |
| 199 | | | | 20% | | 80% | | | | | 0.48 | 0.06 |
| 200 | 50% | | 15% | | | | | 35% | | | 0.46 | 0.07 |
| 201 | 50% | | 25% | | | 25% | | | | | 0.41 | 0.06 |
| 202 | | | | | 15% | 50% | | 35% | | | 0.37 | 0.09 |
| 203 | | | | | | | | | | | 0.64 | 0.14 |
| 204 | | | | | | | | | | | 0.45 | 0.11 |
| 205 | | | | | | | | | | | 0.67 | 0.14 |
| 206 | | | | | | | | | | note 7 | 0.57 | 0.08 |
| 207 | | | | | | | | | | | | |
| 208 | | | | | | | | | | note 8 | 0.49 | 0.14 |
| 209 | | | | | | | | | | note 9 | 0.7 | 0.16 |
| 210 | | | | | | | | | | note 10 | 0.74 | 0.16 |
| 211 | 10% | | | | | 65% | | 25% | | | 0.54 | 0.1 |
| 212 | 25% | | | | | 50% | | 25% | | | 0.49 | 0.1 |
| 213 | 25% | | | | | 50% | | 25% | | | 0.56 | 0.08 |
| 214 | 25% | | | | | 50% | | 25% | | | 0.57 | 0.1 |
| 215 | 25% | | | | | 50% | | 25% | | | 0.56 | 0.08 |
| 216 | 50% | | | | 20% | 30% | | | | | 0.5 | 0.08 |
| 217 | 50% | | | | 20% | 30% | | | | | 0.49 | 0.09 |

| | | | | | | | 1 to 3 | 3 to 10 | | |
|---|---|---|---|---|---|---|---|---|---|---|
| | | | | LED | | | micron | micron | | |
| | | MD | CD | Score | | dP | PFE | PFE | | |
| example | Fraziers | Gurley | Gurley | test | Memory | note 4 | note 5 | note 5 | Index | MERV |
| 134 | 608 | | | 50 | | 0.066 | | 41.6 | 630 | 6 |
| 135 | 502 | | | 93.7 | | 0.094 | | 42 | 447 | 6 |
| 136 | 551 | 1452 | 1378 | 75.1 | | 0.067 | | 34.7 | 518 | 5 |
| 137 | | | | | | 0.037 | | 28.6 | 773 | 5 |
| 138 | 511 | 1846 | 2498 | 66.2 | | 0.083 | | 45.7 | 551 | |
| 139 | 599 | 896 | | | | 0.061 | | 40 | 656 | 6 |
| 140 | 498 | 1517 | | | | 0.081 | | 28.3 | 349 | 5 |
| 141 | 500 | 2326 | 2335 | 63 | | 0.072 | | 47.8 | 664 | 6 |
| 142 | 463 | 2167 | 2470 | 69 | | 0.089 | | 53.1 | 597 | 7 |
| 143 | 488 | 1946 | 2032 | 61.5 | | 0.08 | | 49.5 | 619 | 6 |
| 144 | 465 | 2101 | 2733 | 49.3 | | 0.095 | | 50 | 526 | 6 |
| 145 | 469 | 1678 | 2304 | | | 0.085 | | 51.6 | 607 | 7 |
| 146 | 506 | 2338 | 2372 | 68.7 | | 0.097 | | 56.3 | 580 | 7 |
| 147 | 523 | 3005 | | 71 | | 0.075 | | 51.6 | 688 | 7 |
| 148 | 441 | 2401 | 2737 | 53.3 | | 0.104 | | 55.9 | 538 | 7 |
| 149 | 488 | 2241 | 2303 | 39.7 | | 0.086 | | 56.1 | 652 | 7 |
| 150 | 489 | 1874 | 1420 | 69 | | 0.075 | | 43.8 | 584 | 6 |
| 151 | 425 | 2690 | 2435 | 70 | | 0.094 | | 42.0 | 447 | 6 |
| 152 | 487 | 2179 | 1804 | 71.7 | | 0.081 | | 47.3 | 584 | 6 |
| 153 | 468 | 2265 | 2125 | 63.3 | | | | | | |
| 154 | 476 | 2839 | 2921 | 85.3 | | 0.099 | | 62.0 | 626 | 7 |
| 155 | 383 | 1354 | 1343 | 66 | | 0.122 | | 63.0 | 516 | 7 |
| 156 | 319 | 1695 | 1835 | 58.3 | | | | | | |
| 157 | 428 | 1459 | 1261 | 74.8 | | 0.094 | | 52.0 | 553 | 7 |
| 158 | 428 | | | 83.7 | | | | | | |
| 159 | 468 | 2740 | 2620 | 87 | | 0.099 | | 63.5 | 641 | 7 |
| 160 | 514 | 2173 | 2106 | 63.3 | | 0.069 | | 60.5 | 877 | |
| 161 | 818 | 2269 | 2120 | 83.7 | 4.25 | 0.035 | | 55 | 1571 | |
| 162 | 587 | 1453 | 1463 | 70.7 | | 0.062 | | 35.7 | 576 | |
| 163 | 615 | | | 55.7 | 5.5 | 0.059 | | 50.1 | 849 | |
| 164 | 528 | 2992 | 3009 | 79.7 | 5.13 | 0.083 | | 53.7 | 647 | |
| 165 | 498 | 2302 | 2134 | 62 | | 0.078 | | 59.4 | 762 | |
| 166 | 509 | 3301 | 2473 | 79.2 | | 0.083 | | 50.1 | 604 | |
| 167 | 561 | 3121 | 2219 | 78 | | 0.07 | | 51.4 | 734 | |
| 168 | 580 | 2753 | 2027 | 56 | | 0.061 | | 46.2 | 757 | |
| 169 | 496 | 2300 | 1709 | 73 | | 0.075 | | 45.4 | 605 | |
| 170 | 669 | 2005 | 2321 | 72 | | 0.052 | | 42.7 | 821 | |
| 171 | 620 | 2074 | 2547 | 69.7 | 8.25 | 0.078 | | 59.4 | 762 | |
| 172 | 615 | 2276 | 2216 | 70.2 | 11.25 | 0.064 | | 51.1 | 798 | |
| 173 | 708 | | | 81.2 | | 0.071 | | 42 | 592 | |
| 174 | 549 | 1047 | | 64.5 | | 0.071 | | 45.1 | 635 | |
| 175 | 163 | 7000 | 6800 | | | 0.083 | | 80.6 | 971 | 8 |
| 176 | 163 | 7000 | 6800 | | 79.7 | 0.083 | | 78.3 | 943 | 8 |
| 177 | | | | | | 0.32 | | 75.9 | 237 | |
| 178 | | | | | 96.7 | 0.1 | | 83.4 | 834 | |
| 179 | | | | | | 0.2 | | 78.3 | 392 | |
| 180 | 577 | 1965 | 1501 | 94.3 | 5.25 | 0.041 | | 30.5 | 744 | |
| 181 | 587 | 3508 | 3463 | 96.7 | 7.79 | 0.064 | | 43.5 | 680 | |
| 182 | 574 | 2941 | 2539 | 104.2 | 8.13 | 0.08 | | 40.4 | 505 | |
| 183 | 719 | 2362 | 2216 | 82 | 5.63 | 0.069 | | 33.7 | 488 | |
| 184 | 523 | 1983 | | 69.5 | 5.5 | 0.075 | | 41.7 | 556 | |
| 185 | 545 | 1261 | 1710 | 62.8 | 6.5 | 0.078 | | 42.9 | 550 | |
| 186 | 581 | 1593 | 1993 | 59.3 | 7.75 | 0.062 | | 40.1 | 647 | |
| 187 | 542 | 1280 | 1500 | 59.8 | 6.38 | 0.067 | | 45.1 | 673 | |
| 188 | 508 | 1608 | 1473 | 64.2 | 7.1 | 0.08 | | 46.7 | 584 | |
| 189 | 419 | 3737 | 2945 | 96.2 | 7.9 | 0.112 | | 43.2 | 386 | |
| 190 | 794 | 1872 | 1857 | | | 0.031 | | 36.1 | 1165 | |
| 191 | 713 | 1332 | 1292 | | | 0.037 | | 43.1 | 1165 | |
| 192 | 573 | 1499 | 1354 | | | 0.059 | | 48 | 814 | |
| 193 | 743 | 1593 | 1891 | | | 0.043 | | 43.2 | 1005 | |
| 194 | 614 | 1371 | | 72.2 | | | | | | |
| 195 | 642 | 2067 | | 84.8 | | | | | | |
| 196 | 600 | 2047 | | 77.8 | | 0.054 | | 33.1 | 613 | |
| 197 | 561 | 1248 | 1459 | 77.2 | | 0.082 | | 47.5 | 579 | |
| 198 | 647 | 2253 | 1868 | 105.3 | | 0.065 | | 35.9 | 552 | |
| 199 | 627 | 2519 | 2448 | 98.5 | | 0.065 | | 34 | 523 | |
| 200 | 512 | 2237 | 2193 | 76.5 | | 0.085 | | 46.6 | 548 | |
| 201 | 400 | 1919 | 1467 | 75.7 | | 0.116 | | 47.6 | 410 | |
| 202 | 957 | 903 | 1066 | 77 | | | | | | |
| 203 | 366 | 1279 | 912 | 52 | | | | | | |
| 204 | 886 | 1285 | 1436 | 75.3 | | | | | | |
| 205 | 467 | 1428 | 1712 | 51.7 | | | | | | |
| 206 | 574 | 3064 | 3543 | 94.7 | | 0.067 | | 35.2 | | |
| 207 | | | | | | 0.069 | | 34.8 | | |
| 208 | 560 | 481 | | 68.3 | | 0.057 | 59.2 | 87.8 | 10 | |
| 209 | 259 | 492 | | 48.8 | | 0.167 | 71.4 | 93.3 | 11 | |
| 210 | 323 | 559 | | 45.7 | | 0.141 | 62.9 | 85.8 | 10 | |
| 211 | 671 | 2615 | 2223 | 101.5 | 4 | 0.033 | | 17.8 | 539 | |
| 212 | 569 | 1569 | 2083 | 94.5 | 5.75 | 0.081 | | 43.2 | 533 | |
| 213 | 546 | 3498 | 3683 | 94.7 | 6.63 | | | | | |
| 214 | 561 | 3574 | 3584 | 94.2 | 9.31 | | | | | |
| 215 | 590 | 3382 | 3334 | 101.7 | 8.88 | 0.055 | | 41.1 | 747 | |
| 216 | 466 | 2598 | 2609 | 82 | 6.25 | 0.094 | | 55.7 | 593 | |
| 217 | 472 | 3005 | 2809 | 94.2 | 7.38 | 0.089 | | 51.8 | 582 | |

notes
note 1 - this fiber is a 4 denier, high melting point PET core, low melting point PET sheath bicomponent fiber
note 2 - this fiber is a 15 denier, high melting point PET core, low melting point PET sheath bicomponent fiber
note 3 - thickness is measured on a 12 inch square sample subjected to a compression of 2 grams per square inch.
note 4 - pressure drop
note 5 - particle filter efficiency, ASHRAE 52.2-1999
note 6 - - UNC is uncharged, chgd is charged
note 7 - 25% 2.25 denier, high melting point PET core, low melting point PET sheath bicomponent fibers: 50% 15 denier, high melting point PET core, low melting point PET sheath bicomponent fibers; 25% 45 denier fibers
note 8 - T647D + 0.12 osy triboelectric fibers
note 9 - T647D + 0.06 osy triboelectric fibers
note 10 - T647D + 0.07 osy triboelectric fibers
note 11 - this is a multilayered composite material comprising a a 0.5 osy spunbond layer
note 12 - this is a multilayered composite material formed from two layers of carded fibers.
note 13 - also includes 10% rayon fibers

TABLE 6

| | Number | | Heated roll | |
|---|---|---|---|---|
| Example | heated rolls | Web Heated on | temp. C. | Nip |
| 1 | 0 | | 188 | |
| 2 | 2 | one side | 190 | Open |
| 3 | 2 | one side | 190 | Open |
| 4 | 0 | | 190 | |
| 5 | 0 | | | |
| 6 | 2 | one side | | Open |
| 7 | 0 | | 188 | |
| 8 | 2 | one side | 193 | Open |
| 9 | 0 | | 176 | |
| 10 | 2 | one side | | Open |
| 11 | 0 | | 154 | |
| 12 | 2 | one side | 185 | Open |
| 13 | 2 | one side | 185 | Open |
| 14 | 2 | one side | | Open |
| 15 | 0 | | 188 | |
| 16 | 2 | one side | | Open |
| 17 | 2 | one side | 160 | Closed |
| 18 | 2 | one side | | Open |
| 19 | 2 | one side | 160 | Closed |
| 20 | 0 | two sides | | Closed |
| 22 | 2 | one side | | Open |
| 23 | 0 | | 174 | Open |
| 24 | 0 | | 190 | |
| 25 | 0 | two sides | | Closed |
| 26 | 0 | | 168 | 3.65 |
| 27 | 2 | one side | 201 | Open |
| 28 | 2 | one side | | Open |
| 29 | 2 | one side | 193 | Open |
| 30 | 2 | one side | 204 | Open |
| 31 | 0 | | 190 | |
| 32 | 0 | one side | 188 | Open |
| 33 | 0 | | 190 | |
| 34 | 0 | | 160 | |
| 35 | 0 | | 188 | |
| 36 | 0 | | 190 | ref hl |
| 37 | 2 | one side | | Open |
| 38 | 2 | one side | | Open |
| 39 | 0 | | 190 | |
| 40 | 0 | | 190 | |
| 41 | 2 | one side | 188 | open |
| 42 | 2 | one side | | open |
| 43 | 0 | one side | | open |
| 44 | 0 | | 176 | |
| 45 | 2 | one side | 190 | Open |
| 46 | 2 | one side | 204 | Open |
| 47 | 2 | one side | | Open |
| 48 | 0 | two sides | 188 | Closed |
| 49 | 0 | | 190 | ref hl |
| 50 | 0 | | 188 | |
| 51 | 2 | one side | | Open |
| 52 | 2 | one side | 201 | Open |
| 53 | 2 | one side | 193 | Open |
| 54 | 2 | one side | | Open |
| 55 | 2 | one side | 160 | Closed |
| 56 | 2 | one side | 193 | Open |
| 57 | 2 | one side | 185 | Open |
| 58 | 0 | one side | | Closed |
| 59 | 2 | one side | 160 | Closed |
| 60 | 2 | one side | | Open |
| 62 | 0 | | 190 | |
| 63 | 2 | one side | 174-182 | Open |
| 65 | 2 | one side | 188 | Open |
| 66 | 2 | one side | | Open |
| 67 | 2 | one side | | Open |
| 68 | 2 | one side | | Open |
| 69 | 0 | | 188 | |
| 70 | 0 | one side | 188 | Closed |
| 71 | 0 | two sides | | Open |
| 72 | 2 | one side | | Open |
| 73 | 2 | one side | | Open |
| 74 | 2 | one side | 201 | Open |
| 75 | 2 | one side | | Open |
| 76 | 2 | one side | | Open |
| 77 | 2 | one side | 174-182 | Open |
| 78 | 0 | one side | | Open |
| 79 | 2 | one side | 193 | Open |
| 80 | 2 | one side | | Open |
| 81 | 2 | one side | | Open |
| 83 | 2 | one side | | Open |
| 84 | 2 | one side | | Open |
| 85 | 2 | one side | 201 | Open |
| 87 | 2 | One side | 193 | Open |
| 88 | 2 | one side | 203 | Open |
| 89 | 2 | one side | 201 | Open |
| 90 | 2 | one side | 201 | Open |
| 91 | 2 | one side | | Open |
| 92 | 2 | one side | 193 | Open |
| 93 | 2 | one side | 185 | Open |
| 94 | 2 | one side | 201 | Open |
| 95 | 2 | one side | 201 | Open |
| 96 | 0 | | 160 | |
| 97 | 2 | one side | 201 | Open |
| 98 | 2 | one side | | Open |
| 99 | 2 | one side | 193 | Open |
| 100 | 2 | one side | | Open |
| 101 | 2 | one side | 201 | Open |
| 102 | 0 | | 168 | |
| 103 | 2 | one side | | Open |
| 104 | 2 | one side | | Open |
| 105 | 2 | one side | 174-182 | Open |
| 106 | 2 | one side | 201 | Open |
| 107 | 2 | one side | | Open |
| 108 | 2 | one side | | Open |
| 109 | 2 | one side | 201 | Open |
| 110 | 2 | one side | 193 | Open |
| 111 | 2 | one side | 174-182 | Open |
| 112 | 2 | one side | 201 | Open |
| 113 | 2 | one side | | Open |
| 114 | 2 | one side | 203 | Open |
| 117 | 2 | one side | | Open |
| 118 | 2 | one side | | Open |
| 119 | 2 | one side | | Open |
| 120 | 2 | one side | | Open |
| 121 | 2 | one side | | Open |
| 122 | 2 | one side | | Open |
| 134 | 2 | one side | 201 | Open |
| 135 | 2 | one side | | Open |
| 136 | 2 | one side | 160 | Open |
| 137 | 2 | one side | 160 | Open |
| 138 | 2 | one side | | Open |
| 139 | 2 | one side | | Open |
| 140 | 2 | one side | | Open |
| 141 | 2 | one side | 188 | Open |
| 142 | 2 | one side | 188 | Open |
| 143 | 2 | one side | 188 | Open |
| 144 | 2 | one side | 188 | Open |
| 145 | 2 | one side | 176 | Open |
| 146 | 2 | one side | 188 | Open |
| 147 | 2 | one side | 188 | Open |
| 148 | 2 | one side | 188 | Open |
| 149 | 2 | one side | 188 | Open |
| 150 | 2 | one side | 185 | Open |
| 151 | 2 | one side | 179 | Open |
| 152 | 2 | one side | 179 | Open |
| 153 | 2 | one side | 179 | Open |
| 154 | 2 | one side | 182 | Open |
| 155 | 2 | one side | 182 | Open |
| 156 | 2 | one side | 182 | Open |
| 157 | 2 | one side | 176 | Open |
| 158 | 2 | one side | 176 | Open |
| 159 | 2 | one side | 176 | Open |
| 160 | 2 | one side | 160 | Open |
| 161 | 2 | one side | 171 | Open |
| 162 | 2 | one side | 171 | Open |
| 163 | 2 | one side | 182 | Open |
| 164 | 2 | one side | 171 | Open |
| 165 | 2 | one side | 171 | Open |
| 166 | 1 | one side | 171 | Closed |
| 167 | 1 | one side | 171 | Open |
| 168 | 1 | one side | 176 | Open |
| 169 | 1 | one side | 188 | Open |
| 170 | 2 | one side | 176 | Open |
| 171 | 2 | one side | | Open |
| 172 | 2 | one side | 176 | Open |
| 173 | 2 | one side | | Open |
| 174 | 2 | one side | 176 | Open |
| 175 | 2 | one side | | Open |
| 176 | 2 | one side | | Open |
| 177 | 2 | one side | | Open |
| 178 | 2 | one side | | Open |
| 179 | 2 | one side | | Open |
| 180 | 1 | one side | 174 | Open |
| 181 | 1 | one side | 182 | Open |
| 182 | 1 | one side | 182 | Open |
| 183 | 1 | one side | 174 | Open |
| 184 | 2 | one side | | Open |
| 185 | 2 | one side | 171 | Open |
| 186 | 2 | one side | 171 | Open |
| 187 | 2 | one side | | Open |
| 188 | 2 | one side | 171 | Open |
| 189 | 2 | two sides | 154 | Open |
| 190 | 2 | one side | 193 | Open |
| 191 | 2 | one side | 193 | Open |
| 192 | 2 | one side | 193 | Open |
| 193 | 2 | one side | 193 | Open |
| 194 | 1 | one side | 176 | Open |
| 195 | 1 | one side | 190 | Open |
| 196 | 2 | one side | | Open |
| 197 | 2 | one side | 201 | Open |
| 198 | 2 | one side | | Open |
| 199 | 2 | one side | | Open |
| 200 | 2 | one side | 201 | Open |
| 201 | 2 | one side | 201 | Open |
| 202 | 2 | one side | | Open |
| 203 | 2 | one side | | Open |
| 204 | 2 | one side | | Open |
| 205 | 2 | one side | | Open |
| 206 | 2 | one side | | Open |
| 207 | 2 | one side | | Open |
| 208 | 2 | one side | | Open |
| 209 | 2 | one side | | Open |
| 210 | 2 | one side | | Open |
| 211 | 1 | one side | 174 | Closed |
| 212 | 1 | one side | 174 | Closed |
| 213 | 0 | two sides | 176 | Closed |
| 214 | 0 | one side | 176 | Closed |
| 215 | 0 | two sides | 176 | Closed |
| 216 | 1 | one side | 165 | Closed |
| 217 | 1 | one side | 160 | Closed |

1. An air filtration media comprising a thermally bonded nonwoven web comprising a generally homogeneous mixture of at least two groups of fibers, the web comprising about 30 to about 80% by weight of a first group of fibers having a denier of about 4 or less and a length of about 6 mm to about 200 mm, the fibers of the first group including a first fiber portion extending substantially continuously along the length of each fiber and comprising a first thermoplastic polymeric material having a first melting point and a second fiber portion extending substantially continuously along the length of each fiber and defining at least a portion of a fiber exterior surface, the second fiber portion comprising a second thermoplastic polymeric material having a second melting point lower than the first melting point; and about 20 to about 70% by weight of a second group of fibers having a length of about 6 mm to about 200 mm, at least a portion of the second group of fibers being monocomponent fibers having a denier of 15 or more, the total weight % of the fibers of the first and second groups being 100%; the media having a Frazier permeability of 45,000 LSM to 260,000 LSM, a thickness of about 1.0 mm to about 6.4 mm, an Index in the range of about 300 to about 1600, and a MD Gurley stiffness of at least 1800 mg.

2. The air filtration media of claim 1, wherein the first group of fibers comprises 60% to 70% by weight of 4 denier polyester conjugate fibers, and the second group of fibers comprises 10% to 20% by weight of 15 denier polyester fibers and 10% to 20% by weight of 3 denier polyester fibers.

3. The air filtration media of claim 52, wherein the first group of fibers comprises 58% to 62% by weight of 15 denier polyester conjugate fibers, and the second group of fibers comprises 23% to 27% by weight of 45 denier polyester fibers and 13% to 17% by weight of 2.25 denier polyester fibers.

4. The air filtration media of claim 1, wherein the first group of fibers comprises 73% to 77% by weight of 4 denier polyester conjugate fibers, and the second group of fibers comprises 13% to 17% by weight of 15 denier polyester fibers and 8% to 12% by weight of 0.9 denier polyester fibers.

5-13. (canceled)

14. The air filtration media of claim 1, wherein the media has a basis weight in the range of about 90 g/m² to about 370 g/m².

15. The air filtration media of claim 1, wherein the media is formed of only two groups of fibers.

16. The air filtration media of claim 1, wherein the media has a LED score between 39.7 and 105.3 degrees.

17-18. (canceled)

19. The air filtration media of claim 52, wherein the first group of fibers contains up to 85% by weight of 15 denier conjugate fibers and the media has a LED score between 39.7 and 105.3 degrees.

20-26. (canceled)

27. The air filtration media of claim 1, wherein the second group of fibers comprises chargeable polypropylene fibers.

28-29. (canceled)

30. The air filtration media of claim 1, wherein the first thermoplastic polymeric material is polyester.

31. The air filtration media of claim 1, wherein the first thermoplastic polymeric material is polyester and the second thermoplastic polymeric material is polyester.

32. The air filtration media of claim 1, wherein the second group of fibers further comprises kenaf fibers having a length of about 10 mm to about 200 mm.

33. (canceled)

34. (canceled)

35. The air filtration media of claim 1, wherein the media is further comprised of non-fibrous binder.

36. The air filtration media of claim 1, wherein the second group of fibers further comprises at least one member selected from the group consisting of recycled polyester fibers, rayon fibers and cotton fibers.

37. (canceled)

38. The air filtration media of claim 1, wherein the media is charged.

39-40. (canceled)

41. The air filtration media of claim 1, wherein the media has more than one layer.

42-47. (canceled)

48. A method of producing an air filtration media comprising:
obtaining first and second groups of fibers, the first group comprising polyester fibers having a length of about 6 mm to about 200 mm and a fineness of 4 denier or less the fibers of the first group including a first fiber portion extending substantially continuously along the length of each fiber and comprising a first thermoplastic polymeric material having a first melting point and a second fiber portion extending substantially continuously along the length of each fiber and defining at least a portion of a fiber exterior surface, the second fiber portion comprising a second thermoplastic polymeric material having a second melting point lower than the first melting point; the fibers of the second group having a length of about 6 mm to about 200 mm, at least a portion of the second group of fibers being monocomponent fibers having a denier of 15 or more;
joining the first and second groups of fibers by mechanical entanglement to form a matt,
thermally bonding the first and second groups of fibers by application of heat on up to two sides of the matt, and adjusting the stiffness and foldability properties of the matt by altering the thermal bonding temperature, whereby lower stiffness and foldability values are obtained with increasing thermal bonding temperature.

49. The method of claim 48, wherein the first and second groups of fibers are thermally bonded using up to two heated rolls having a temperature between 154° C. and 204° C.

50-51. (canceled)

52. An air filtration media comprising a thermally bonded nonwoven web comprising a generally homogeneous mixture of at least two groups of fibers, the web comprising about 30 to about 85% by weight of a first group of fibers having a denier of about 10 or more and a length of about 6 mm to about 200 mm, the fibers of the first group including a first fiber portion extending substantially continuously along the length of each fiber and comprising a first thermoplastic polymeric material having a first melting point and a second fiber portion extending substantially continuously along the length of each fiber and defining at least a portion of a fiber exterior surface, the second fiber portion comprising a second thermoplastic polymeric material having a second melting point lower than the first melting point; and about 15 to about 70% by weight of a second group of fibers having a length of about 6 mm to about 200 mm, at least a portion of the second group of fibers being monocomponent fibers having a denier of 3 or less, the total weight % of the fibers of the first and second groups being 100%; the media having a Frazier permeability of 45,000 LSM to 260,000 LSM, a thickness of about 1.0 mm to about 6.4 mm, an Index in the range of about 300 to about 1600 and a Gurley stiffness of at least 1800 mg.

53. The air filtration media of claim 1, wherein the first group of fibers comprises 4 denier conjugate fibers, and the second group of fibers comprises 15 denier polyester fibers.

54. The method of claim 48, wherein the matt has an Index in the range of 300 to 1600 after thermal bonding.

55. The method of claim 54, wherein the air filtration media has a retained foldability of 54-101 degrees when measured by the LED score test.
